(19) United States
(12) Patent Application Publication
(10) Pub. No.: US 2017/0293878 A1
(43) Pub. Date: Oct. 12, 2017

(54) SYSTEM AND PROCESS FOR MATCHING SENIORS AND STAFFERS WITH SENIOR LIVING COMMUNITIES

(71) Applicant: SOFTVU LLC, Kansas City, KS (US)

(72) Inventors: Timothy J. Donnelly, Leawood, KS (US); Paul T. Goldman, Augusta, KS (US); Daniel J. Cates, Overland Park, KS (US); Nicholas M. Peeples, Prairie Village, KS (US)

(73) Assignee: SOFTVU LLC, Kansas City, KS (US)

(21) Appl. No.: 15/485,129

(22) Filed: Apr. 11, 2017

Related U.S. Application Data
(60) Provisional application No. 62/321,552, filed on Apr. 12, 2016.

(51) Int. Cl. G06Q 10/06; G06Q 30/02; G06F 17/30; G06Q 10/10

(52) U.S. Cl. CPC G06Q 10/063112; G06Q 10/1053; G06Q 30/0201; G06F 17/30867; G06F 17/30554; G06F 17/3053

(57) ABSTRACT

A system and method for generating and scoring leads for senior living communities, which collects and processes event and attribute data for seniors, senior living communities and staffers, and presents filtered and scored lists of potential senior residents and potential job applicants to senior living community operators. The matching, filtering and scoring of leads is based on early indicators of imminent senior care need, the communities' demographic and event qualifiers for candidates, the demographic traits of the current populations of the senior living communities, and weights assigned to the demographic qualifiers, event qualifiers and demographic traits by the senior living communities or system operator. Embodiments of the present invention can also be used by senior care seekers and job seekers to identify and score compatible senior care living communities based on demographic qualifiers, event qualifiers and weights provided by the senior care seekers, the job seeker, or system operator.

### FIELD OF ART

The present invention relates generally to systems and processes for identifying potential customers and potential staffers for senior living communities, and more particularly to computer-implemented systems and processes that automatically identify, score and present potential matches between senior citizens, senior living communities and job applicants for senior living communities based on a combination of early indicators of senior care need, the attributes of the seniors, the staffers and the communities, and weights provided by the seniors, staffers and senior living communities reflecting their priorities in respect to certain attributes.

### BACKGROUND

There are roughly 40 million people in the United States that are 65 years old or older. Roughly 20 million of these elderly people are at least 75 years old. Moreover, in the United States, about ten thousand more people turn 65 every day. By the year 2040, the population of seniors living in the United States that are 65 years old or older will be double of what it is today. Many of these senior citizens will need some type of senior care as they get older and begin to find it more and more difficult to manage life on their own without some type of full or part-time assistance. Some of these seniors will move in with their adult children. Others, however, will choose, for a variety of different reasons, to move into a senior living community. However, the conventional processes for identifying, researching, contacting and visiting senior living communities in order to find a good fit for the senior (based on the senior's financial resources, health condition, social and recreational requirements), and personality, can be extremely daunting for both the senior and his or her close relatives.

There are approximately 15,000 senior assisted-living communities in the United States. The average length of stay for a senior community resident is only about 22 months, which means most senior living communities are faced with the daunting task of filling approximately 55% of its rooms each year, due solely to the high turnover rate for seniors. Consequently, despite an ever-growing number of seniors, most senior living communities are barely making a profit due to extremely high turnover rates on beds and rooms, short residency periods for most of their residents, and significant administrative obstacles and financial costs associated with the conventional processes for finding new (and hopefully longer term) residents. The most important factor in a senior living community's profit potential is its ability to reach maximum (or near-maximum) occupancy. Because increasing occupancy is the primary goal, senior living communities will often seek out and accept residents who can move into the community in the shortest amount of time. However, seniors who move into senior living communities the fastest usually have serious or acute medical conditions, which, unfortunately, often results in those seniors passing away and the community having another vacancy to fill in the very near future.

In today's market, senior living communities rely on “lead aggregation” companies to provide leads to eligible seniors. Approximately 30-40% of all leads come from third-party referrals (online lead aggregators) and 60-70% come from professional referrals or organic community marketing efforts. However, a lead often comprises nothing more than contact information for an elderly person, such as the person's name, age and street address. In rare cases, the lead may also include an email address. This means it is up to the operator of the senior living community to determine whether the identified person is a good candidate for residency and how much time, effort and money, if any, should be expended nurturing the lead and trying to get the identified person to move into the senior living community.

Typically, if the lead aggregator provides a lead to a senior living community, and that lead results in a “move-in” the senior living community will be obligated to pay a fee to the lead aggregator, which is on average 80-100% of the first month's rent. This fee typically amounts to about $3,500 to $5,000. Notably, the contracts between lead aggregators and senior living communities usually require that the senior living community pay the lead aggregator this fee every time any one of the seniors previously identified by the lead aggregator moves into the community—regardless of whether the community operator actually used the list of leads supplied by the lead aggregator to find the senior. Consequently, the largest expenses for a senior living community, after rent, debt service and payroll, are usually sales expenses related to paying lead aggregators to find new residents, despite the fact that those new residents may only live in the community for a short period of time. Moreover, the “sales staff” for most senior living communities typically comprises only one person per 50-100 rooms, and this person may also be responsible for tours, move-in logistics, scheduling recreational activities for current residents, etc.

Another significant problem that plagues most senior living communities, and negatively impacts profitability, is the problem of attracting, recruiting and retaining qualified and experienced staff members, especially staff members who are hired to work in the lower paying and/or hourly wage positions. The staff members who are hired to take care of many essential jobs in a senior living community, such as cooking, cleaning, changing bedsheets and bedpans, helping senior residents move about the facility in wheelchairs and walkers, etc., typically do not stay at a single community very long. It is not uncommon, for example, for hourly-wage staff members to resign from one senior living community and go work at a new senior living community because the new senior living community pays as little as10 cents more per hour for doing the same job. Consequently, staff turnover in senior living communities averages 70-100% per year. The high turnover rates for staff members frequently causes dissatisfaction and complaints from senior residents (and their families), who dislike changes in personnel, changes in their daily routines or being cared for by staff members that they consider to be strangers. So the high turnover rates of staff members often leads to more residents moving out, which in turn leads to lower profits, which in turn leads to lower pay for the staff members that remain. Thus, many senior living communities are caught up in a never-ending cycle of low occupancy and resident and staffing turnover problems, which drives down profits and profitability.

Accordingly, there is a substantial and rapidly increasing need in the senior living community industry for systems and processes of identifying suitable matches between senior living communities and seniors who have, or will soon have, a need for senior care. There is a further need in the industry for systems and processes for finding good matches earlier in the seniors' lives, long before the potential candidate's physical or medical condition becomes so serious or acute that turning the candidate into a happy and healthy long-term resident is unlikely. There is also considerable need for systems and processes for matching senior living communities and qualified staff member candidates. None of these needs are addressed by conventional systems and processes for identifying candidates for senior care and qualified candidates for employment at senior living communities.

### BRIEF SUMMARY OF THE INVENTION

The present invention addresses these needs by providing systems and processes for generating and scoring potential customer and staff leads for senior living communities, as well as potential community leads for seniors and staffers. To this end, embodiments of the invention collect and process event and attribute data for seniors, senior living communities and staffers, and present matched and scored lists of potential senior residents, potential job applicants and potential senior living communities. The identification, matching and scoring of leads is based on early indicators of imminent senior care need, the communities' demographic and event qualifiers for candidates, the demographic traits of the senior living communities' current populations, and weights assigned to the qualifiers and demographic traits by the users.

Various aspects of the invention may be implemented on an online platform, a public or corporate network, a private network server, a personal computer system or mobile device, such as a smart phone or tablet computer. In preferred embodiments, a senior living community can use the system to identify, select and claim leads to eligible seniors, while seniors (and their family members, healthcare providers and friends) can use the system to identify and select leads comprising favorably matched and scored senior living communities. In some implementations, if a community operator selects a lead, it may purchase the contact information for the lead from the platform operator by selecting the appropriate option, and may also initiate targeted marketing campaigns to cause the system to automatically engage with that lead on behalf of the senior living community. In other implementations, the community operator may elect to pay the platform operator when a senior identified by the platform as a suitable match tours or moves into the senior living community. Accordingly, embodiments of the present invention may reduce the communities' reliance on lead aggregators, and save the community a significant amount of time and money by providing well-matched leads and marketing capabilities that the senior living community cannot develop and deploy on its own. The invention also reduces the amount of time and energy seniors or their family members and care providers must spend looking for compatible senior living communities.

In one aspect of the present invention, there is provided a process for identifying potential customers for senior living communities using a lead generating system. In general, the method comprises the steps of: creating a leads dataset on the lead generating system; creating a community dataset on the lead generating system by monitoring a community data source to identify and store a senior care type, a plurality of senior living communities that provide the senior care type, community demographic attributes and community events associated with the plurality of senior living communities. The process also includes monitoring an early indicator data source to detect an early indicator for the senior care type, to detect a potential customer for the senior care type, and to collect customer demographic attributes for the potential senior citizen customer. The method further includes the steps of comparing the customer demographic attributes to the community demographic attributes for a senior living community in the community dataset to establish a match between the potential customer and the senior living community. If a match is found, a potential customer record is created in the leads dataset containing the customer demographic attributes for the potential customer, the community events and the senior care type. Then the system establishes a data communications link with a computer system and/or display device controlled by the senior living community, or controlled by an agent for the senior living community, so that at least a portion of the potential customer record in the leads dataset can be transmitted from the lead generating system to the display device controlled by the senior living community via the data communications link.

In some implementations, the process further includes steps for calculating and displaying (or transmitting) persona scores for the potential customer based on a demographic qualifier, a trait qualifier and an event qualifier (or some combination of demographic, trait and event qualifiers) provided by the senior living community or a system operator. Suitably, these steps may include calculating a senior persona score for the potential customer, the senior persona score including a demographic qualifier score, a trait qualifier score and an event qualifier score; receiving from the senior living community, via the data communications link, a demographic qualifier for a community demographic attribute, the demographic qualifier comprising a community-specified value for the community demographic attribute and a demographic qualifier weight that the senior living community (or a system operator) has assigned to the community-specified value for the community demographic attribute. The process may optionally include receiving a trait qualifier for a common demographic attribute for the current population of the senior living community, the trait qualifier comprising a community-specified value for the common demographic attribute for the population of the community and a trait qualifier weight that the senior living community (or system operator) assigns to the community-specified value for the common demographic attribute. The process may also include the steps of receiving an event qualifier for a senior event associated with the senior. The event qualifier comprises a community-specified value for the senior event and an event qualifier weight that the senior living community (or system operator) assigns to the community-specified value for the senior event. The process compares the community-specified values for the qualifiers to the corresponding customer values associated with the potential customer for the qualifiers, and adds the demographic qualifier weights, the trait qualifier weights and the event qualifier weights to the senior persona score for the potential customer if the customer values for the qualifiers are determined to equivalent (or substantially equivalent) to the community-specified values. After a persona score is calculated for the potential customer, it is typically transmitted to the display device operated or controlled by senior living community via the data communications link. In some cases, the demographic qualifier score may be the only qualifier score used to calculate the total persona score. In other cases, the trait qualifier score may be the only qualifier score used to calculate the total persona score. In still other case, the event qualifier score may be the only qualifier score used to calculate the total persona score. In still other cases, the persona score for the senior will be calculated by calculating the sum of the demographic qualifier score, the trait qualifier score and the event qualifier score.

In another aspect of the present invention, a customer lead generating system for senior living communities is provided. The customer lead generating system, which may reside on a personal computer, a laptop or table computer, a mobile device, or a computer server, creates and displays a scored (or ranked) list of matching seniors for a senior living community, wherein the scores are based on demographic and event qualifiers provided by the senior living community, demographic attributes of the current population of the senior living community, and weights assigned to the demographic qualifiers, trait qualifiers and event qualifiers by the senior living community or a system operator. The physical and logical components of the lead generating system may include a leads dataset, a community dataset for storing a senior care type, a plurality of senior living communities that provide the senior care type, community event records, and community demographic attributes associated with the plurality of senior living communities in a target area. The system also includes a data collector that retrieves early indicator data from an early indicator data source (such as a database of home sales); an event processor that processes the early indicator data to detect an early indicator for the senior care type, a potential customer for the senior care type, customer demographic attributes for the potential customer and senior events. A senior to community matching engine compares the customer demographic attributes to the community demographic attributes for the senior living community to establish a match between the potential customer and the senior living community. The senior to community matching engine also creates a potential customer record in the leads dataset, the potential customer record comprising the customer demographic attributes for the potential customer and the senior care type. A data communications link establishes a communication channel to a computer system operated or controlled by the senior living community. A web server uses the data communications link to transmit at least a portion of the potential customer record in the leads dataset from the customer lead generating system to the computer system operated or controlled by the senior living community.

To generate the persona scores for the potential customer, the customer lead generating system also includes a persona score calculator, which calculates a senior persona score for the potential customer, using a demographic qualifier score, a trait qualifier score, an event qualifier score, or all of them, and compares a community-specified value for the community demographic attribute to a customer value associated with the potential customer for the community demographic attribute. Then the persona score calculator adds the weights of the qualifiers to the senior persona score if the customer value for the community demographic attribute is equal to the community-specified value for the community demographic attribute. Finally, the system transmits the senior persona score for the potential customer to the computer operated or controlled by the senior living community via the data communications link.

In still another aspect of the invention, a computer system for calculating and displaying senior persona scores for non-resident seniors for a senior living community is presented. Generally, the computer system includes a microprocessor, a data collector module, an event processing module and a scoring module. The data collector module includes programming instructions that, when executed by the microprocessor, causes the microprocessor to monitor an external data source for events associated with seniors and senior living communities. The event processor module has programming instructions that, when executed by the microprocessor, causes the microprocessor to use the event data collected by the data collector to create a senior dataset, the senior dataset comprising senior demographic attributes, including names and addresses, for seniors in a target population, and to create a community dataset, the community dataset comprising a community address, a set of common demographic attributes for the seniors who live in the senior living community, a set of operator-specified values for the set of common demographic attributes, and a set of weight rules associated with the set of operator-specified values, respectively.

The scoring module has programming instructions that, when executed by the microprocessor, causes the microprocessor to generate a trait qualifier for every operator-specified value for every common demographic attribute in the set of common demographic attributes. This is accomplished by calculating a value density for every operator-specified value and then applying the weight rule based on the calculated value density. The scoring module then cross-references the names and addresses of the seniors in the senior dataset with the community address in the community dataset to identify a non-resident senior for the senior living community. Then the scoring module uses the senior demographic attributes from the senior dataset to determine the non-resident senior's value for every common demographic attribute in the set of common demographic attributes. Next, the scoring module compares the non-resident senior's value to the operator-specified value for each common demographic attribute in the set of common demographic attributes, and adds the trait qualifier for the operator-specified value to the senior persona score for the non-resident senior if the non-resident senior's value for a common demographic attribute is equal to the operator-specified value for the common demographic attribute. In this manner, the non-resident senior's overall persona score rises or falls, depending on how many of the traits of the non-resident senior match the trait qualifiers generated by the system for the senior living community. Notably, some of the trait qualifiers may be expressed in negative numbers, which results in score reductions if the non-resident senior has any traits that the senior living community wishes to avoid, but has not outright prohibited.

### BRIEF DESCRIPTION OF THE DRAWINGS

The present invention and various aspects, features and advantages thereof are explained in detail below by reference to the exemplary and therefore non-limiting embodiments shown in the figures, which constitute a part of this specification and include depictions of the exemplary embodiments. In these figures:

FIGS. 1A, 1B and 1C show three flow diagrams illustrating three exemplary implementations of the invention.

FIG. 2 shows a high-level flow diagram illustrating by way of example the steps performed in the main algorithm for matching and scoring senior personas in real time in response to a community operator's instructions.

FIG. 3 shows examples of community attributes in one implementation of the invention.

FIG. 4A shows examples of senior attributes in one implementation of the invention.

FIG. 4B shows examples of staffer attributes in one implementation of the invention.

FIG. 5 shows examples of child attributes that may be used in implementations of the invention.

FIG. 6 shows a high-level flow diagram illustrating by way of example the steps performed in an algorithm for collecting and processing community data for the community information dataset.

FIGS. 7 and 8 show a high-level flow diagram illustrating by way of example the steps performed in an algorithm for collecting and processing senior data for the senior information dataset.

FIG. 9 shows a high-level flow diagram illustrating by way of example the steps performed in an algorithm for matching and scoring seniors for a community in real time during an operator's online session, wherein the matching and scoring is carried out on a many-to-one basis.

FIG. 10 shows a high-level flow diagram illustrating by way of example the steps performed in an algorithm for pre-matching seniors and senior living communities prior to receiving the community operator's search request, and then scoring the senior personas for the matched seniors in real time after receiving the community operator's scoring instruction.

FIG. 11 shows a high-level flow diagram illustrating by way of example the steps performed in an algorithm for matching seniors and senior living communities prior to receiving the community operator's search instruction, wherein the matching is carried out on a many-to-many basis.

FIG. 12 shows a high-level flow diagram illustrating by way of example the steps performed in an algorithm for scoring senior personas in real time for seniors picked from a list by a community operator.

FIG. 13 shows a high-level flow diagram illustrating by way of example the steps performed in an algorithm for scoring senior personas for all seniors in the senior dataset for all communities in the community information dataset.

FIG. 14 shows a high-level flow diagram illustrating by way of example the steps performed in an algorithm for generating trait qualifiers, which is called out in step 1330 of the flow diagram of FIG. 13.

FIG. 15 shows examples of inputs and outputs for the senior persona trait qualifier generating algorithm illustrated in the flow diagram of FIG. 14.

FIG. 16 shows a table illustrating by way of example how trait qualifiers might be generated for one senior living community based on the common demographic traits of that community.

FIG. 17 shows a high-level flow diagram illustrating by way of example the steps performed in an algorithm for scoring community personas for presentation to seniors looking for compatible senior living communities.

FIG. 18 shows a high-level flow diagram illustrating by way of example the steps performed in an algorithm for generating trait qualifiers for use in the community persona scoring algorithm illustrated in the flow diagram of FIG. 17.

FIG. 19 shows examples of inputs and outputs for the community persona trait qualifier generating algorithm illustrated in the flow diagram of FIG. 18.

FIG. 20 shows a high-level flow diagram illustrating by way of example the steps performed in an algorithm for scoring senior personas.

FIG. 21 shows a high-level block diagram of an exemplary computer network arranged and configured to operate according to one implementation of the invention.

FIG. 22 shows a diagram illustrating the relative senior persona scores of a collection of seniors A-M as viewed from the perspective of a senior living community X according to one implementation of the invention. The diagram of FIG. 22 also illustrates the relative community persona scores for a collection of senior living communities A-M as viewed from the perspective of a senior X searching online for a compatible senior living community.

FIGS. 23, 24A, 24B and 25 through 30 contain exemplary screenshots from a web interface to the computer network of one embodiment of the present invention.

### DETAILED DESCRIPTION OF THE EXEMPLARY EMBODIMENTS SHOWN IN THE FIGURES

The present invention provides system and process for generating leads having several modes of operation. In a first mode of operation, the lead generating system and process permits senior living community operators (or their agents) to search for and identify favorable candidates for their senior living communities. The invention also permits a senior living community operator to calculate and display relative scores for senior citizens who would be good matches for the senior living community. The matching and the scoring of the senior citizen candidates is based, at least in part, on early indicators of an imminent senior care need, certain demographic qualifiers, such as the location, gender and type of care required by the senior citizen candidates, and a comparison of the personal attributes of the senior citizen candidates to the personal attributes of the current population of the senior living community. While identifying, matching and scoring senior citizen candidates for the community, the lead generating system may also take into account certain event qualifiers supplied by the senior care living community operator to enhance the scores of senior citizen candidates who have performed some action or been affected by some event suggesting an existing interest in a particular senior living community, a particular type of care or need, or a particular service or amenity.

The system produces, transmits and/or displays for the senior living community operator a scored (or ranked) list of well-matched leads to senior citizen candidates. The senior living community operator may then use the list of leads to develop and run targeted marketing campaigns designed to persuade those leads to visit the senior living community, perhaps take a tour, and eventually move into the senior living community. Thus, the lead generating system of the present invention helps senior living community operators focus their time, effort and money on leads that are compatible with the current population of the senior living community, on leads that are more likely to respond favorably to the services, amenities and marketing programs of the senior living community, and leads that are more likely to want to move into the senior living community.

In a second mode of operation, the lead generating system of the present invention permits senior citizens (or their family members or healthcare providers) to identify and score ideal senior living communities for their particular situations, based on, among other things, the senior citizens' personal attributes, healthcare needs and financial condition. In this mode, senior citizens can use the lead generating system to search for compatible senior living communities and calculate community persona scores for those matching senior living communities. To this end, the online scoring and matching system is configured to produce, transmit and/or display for the senior citizen a scored list of senior living communities, which the senior (or his or her family or healthcare provided) can then use to find an ideal home. While identifying, matching and scoring senior living communities for the senior, the lead generating system may also take into account certain demographic and event qualifiers supplied by the senior (or a system operator) to enhance the scores of senior living communities that offer particular services and amenities, or to enhance the scores of senior living communities affected by some event that is important to the senior for purposes of that senior making a decision on where he or she wishes to live.

In a third mode of operation, the lead generating system permits senior living community operators (or their agents) to search for, identify and assign relative scores to potential staff employees who would be good matches for the senior living community, and therefore would be more likely to accept employment and remain employed at the senior living community for a significant period of time. The matching and the scoring of the staff candidates is based, at least in part, on demographic qualifiers supplied by the senior living community, such as whether the candidate has a certified nursing association certificate, or other credential. The lead generating system may also take into account demographic, trait and event qualifiers in this mode of operation to enhance the scores of staff candidates who have certain qualities or traits, or who have taken some step or action suggesting an existing interest in working at the particular senior living community, such as submitting a resume or job application to the senior living community, or having an existing relationship with someone who already works at or lives in the senior living community.

In a fourth mode of operation, the lead generating system of the present invention permits potential staff members to identify and score ideal senior living communities for potential employment, based on, among other things, the benefits, services and amenities offered by the senior living community, as well as the staffer's personal attributes, experience, training, pay requirements, location, etc. As in other modes, the lead generating system operating in this mode may also take into account certain demographic and event qualifiers supplied by the potential staffer to enhance the scores of senior living communities that offer services, benefits and amenities, or that possess some attribute or quality that happens to be particularly important to the potential staffer for purposes of that potential staffer making a decision on where he or she wishes to work.

To facilitate the matching and scoring of seniors, staffers and senior living communities on the system, the system creates, populates and periodically updates a dataset of senior citizen information (referred to as the senior dataset), a dataset of staff information (referred to as the staffer dataset) and a dataset of senior living community information (referred to as the community information dataset). All of these datasets are subsequently accessed and used by the system during the matching and scoring phases of all four modes of operation. The system periodically scans external datasets and other external sources of information to retrieve, process and store both private and publicly held information about the senior citizens, the staff candidates and the senior living communities in a target area. The target area may comprise a neighborhood, a city, a county, a state, an area of the country, an entire country, a region of the world, the entire world, or any combination of such areas.

Early Indicators of Senior Care Need.

An early indicator of senior care need may arise from any action or event typically associated with people who are at an age or have a condition suggesting that they may soon need senior care for themselves or a loved one, such as a parent or grandparent. The most obvious early indicators of senior care need occur when a senior (or a family member or caretaker for a senior) visits a senior living community in person for a tour, or registers on a senior living community's website to receive additional information about the services provided by that senior living community. However, early indicators of senior care need also may be found, for example, in any database, website, list or other resource typically associated with life events tending to affect or concern senior citizens. Such life events may include, for example, purchasing a wheelchair or walker, becoming a widow or widower, selling a home after 30 or more years of ownership, moving in with an adult child, creating a last will or planning an estate. Early indicators of senior care need also may be found in registration and sign-up lists for certain magazines, programs, clubs, and organizations concerned with topics and issues that are most relevant to seniors (such as AARP, reverse mortgage programs and veterans' groups).

Senior Attributes.

The senior citizen data stored in the senior dataset may comprise a variety of different types of senior attributes, including without limitation, early indicators of senior care need, demographic attributes (such as names, ages, addresses, race, gender, marital status and disabilities, residential histories, financial statuses and hobbies, and senior events (such as taking a tour, responding to an advertisement, or having a spouse pass away). The external datasets and other external sources scanned to obtain this information may include, without limitation, census data, real property sales listings, county property registrations, the National Change of Address database, direct mail suppression lists (for deceased persons), automobile sales records, motor vehicle department records, obituaries (containing names of widows and widowers), registrations on websites containing content of special interest to seniors, records associated with buying, selling and registering wheelchairs and walkers, ambulatory records, etc. Systems and processes of the present invention may be configured to monitor, retrieve and process data from any combination of these resources via a variety of different mechanisms, including without limitation, using data gathering web crawlers and website scrapers. The data obtained from these sources and stored in the senior dataset also may be supplemented with additional data obtained through surveys, data subscription services and commercial list sellers and services.

Over time, the lead generating system will collect a considerable amount of data about senior citizens in a target area, including historical data reflecting early indicators of senior care need, and historical data reflecting the changing residential statuses of seniors, including which seniors actually moved into a senior living community, where they decided to move, how long they stayed there, and when they moved out. As the volume of historical data grows, the lead generating system will automatically improve and refine its ability to predict move-in dates based on the early indicators by comparing the types of early indicators associated with newly identified senior candidates to the types of early indicators associated with large numbers of other, similarly-situated seniors who have already moved into senior living communities.

Senior Living Community Attributes.

The community information dataset is configured to store a variety of senior living community attributes. A senior living community attribute may comprise any quality, trait or characteristic of a community, including without limitation, location, religious affiliations, services offered (e.g., assisted living, memory care, skilled nursing, etc.), amenities (e.g., room types, restaurants, recreational activities and nearby points of interest), corporate relationships and affiliations, etc. The community information dataset also stores demographics (e.g., ages, genders, religious or military affiliations, male to female ratios, resident economic statuses, social networks, etc.) for the community's current senior resident population. Some of these community attributes and demographics are obtained from the senior living community operator as part of the onboarding process for the lead generating system. Community demographic attributes may also be obtained from third party sources, such as census datasets, utility service records, subscription service records, drivers license registration records and/or third party data aggregators.

Creating and Scoring Senior Living Community Personas.

The lead generating system of the present invention determines and uses common demographic attributes of the community's current population to create a “community persona” for each senior living community. A common demographic attribute is a demographic attribute for which two or more residents in the community have the same value. For example, a religious affiliation is one example of a demographic attribute for which one would expect to find commonality among multiple residents because multiple residents will have the same value for that particular attribute (or trait). Common demographic attributes also have different values. Religious affiliation, for instance, is a common demographic attribute for which a community is likely to have several different values (e.g., Catholic, Baptist, Jewish, Atheist, etc.) Each value for a common demographic attribute will have a “value density.” For instance, if the common demographic attribute in question is religious affiliation, and a community of 100 residents consists of 50 Jewish residents, 25 Catholic residents, 10 Baptist residents and 15 Atheists, then the value density of the Jewish trait is 50%, the value density of the Catholic trait is 25%, the value density of the Baptist trait is 10%, and the value density of the Atheist trait is 15%. Thus, each common demographic attribute could have several possible values, and each possible value for a specified demographic attribute for a community may have a different value density.

A community persona is a collection of attributes (and attribute values) that, in combination with each other, tend to reflect the significant demographic traits of the current residents of the community in terms of the value densities of particular attributes. Because a community persona is based on the common demographic attributes of the current population of that community, and the value densities of common demographic attributes will change when residents move into or out of the community, the community persona for a senior living community may evolve over time, depending on the traits of seniors who move in and move out of the senior living community, and the timing of their move-ins and move-outs. Therefore, the community persona of a senior living community today could be considerably different from the community persona of the same senior living community six months from now or a year ago. In recognition of this fact, implementations of the present invention are suitably configured to periodically collect and compile new data about the seniors and senior living communities in the target geographic location, including new and up-to-date information about the demographic traits of the seniors who have recently moved into or moved out of the senior living communities. As this information is updated, the community personas used by the system for matching purposes are also updated to reflect the changes in the value densities of the traits of the current population. The frequency of these periodic updates for the personas may be suitably tuned, depending, for example, on the current occupancy turnover rates in a particular community or a particular area.

Once a community persona is created, embodiments of the present invention can score the community persona based on demographic and event qualifiers. These demographic and event qualifiers may be supplied by the senior looking at the community, the system operator, or both the senior and the system operator. If a community persona closely matches the attributes of the particular senior looking at that community, then embodiments of the present invention will give that community a higher community persona score for that particular senior. Thus, a “community persona score” for a senior is a number that represents, from the perspective of the senior, the relative compatibility between the senior and the community, based on demographic qualifiers (such as geographic location, whether or not the community has a certain amenity, like a swimming pool or restaurant, etc.), trait qualifiers (which are based on the demographic attributes of the current population of the community), event qualifiers (such as online reviews, whether the community has a waiting list, or has been recommended by a friend). Therefore, when a senior is presented with the community persona scores for two communities that “match” the senior's geographic, care-type and financial condition requirements, the matched community with the relatively higher community persona score is considered by the lead generating system to be a better fit for the senior (i.e., a better match) than the matched community that has the relatively lower community persona score.

Creating and Scoring Senior and Staff Personas.

Embodiments of the present invention also periodically create “senior personas” for the seniors in a target population and scores those senior personas in real time in order to provide community operators with up-to-date information the operator can use to evaluate the desirability of a particular lead. A “senior persona score” is a number that reflects, from the perspective of the community, a relative compatibility between the community and the senior based on comparisons between the attributes of the lead and certain demographic qualifiers and event qualifiers supplied by the senior living community. The senior persona score for a lead may also be influenced by certain trait qualifiers, which are comparisons between the traits of the lead and the traits (expressed in terms of value densities) of the current population of the community. Thus, as between two matched seniors, the matched senior with the relatively higher senior persona score is considered by the online scoring and matching system to be “the better match,” for the community, and therefore more likely to move into the selected community and stay longer than the matched senior who has a relatively lower senior persona score.

Each community can have a different senior persona score for each senior that might move into that community. For example, if there are five communities in an area and 10 senior candidates inside or near that area, then there will be 50 different senior persona scores for those 10 seniors, because although those seniors have the same geographic attribute (location), they may be more or less valuable to one of the five communities based on other attributes, such as age, medical condition, or ability to pay for the services provided by those communities. From the perspectives of the seniors, a community persona score will exist for every community in the country and the score could be a different number for every senior-community combination. Likewise, from the perspectives of the communities, a senior persona score will exist for every senior in the country and the score could be a different number for every community-senior combination.

For example, a single senior may have significantly different senior persona scores for two different communities in his or her neighborhood because the two communities may have very different demographic qualifiers, event qualifiers and weighting systems for seniors. Thus, senior John Doe may have a senior persona score of 75 for community A and a senior persona score of 45 for community B because community A has a population that has much more in common with senior John Doe than community B. The senior persona scores may also be different for the two different communities because the two communities have different demographic or event qualifiers that are impacted by senior John Doe's demographic attributes or events. Thus, community B′s senior persona score for senior John Doe could be lower than community A′s senior persona score for John Doe because senior John Doe is an avid swimmer, and community A has a swimming pool, while community B does not.

Embodiments of the present invention also periodically create and score “staff personas” for qualified workers in the target geographic location based on certain attributes associated and certain events associated with potential staff persons. The system also scores those staff personas in real time to provide community operators with up-to-date information the operator can use to evaluate the compatibility of a particular staff person with the senior living community. A “staff persona score” is a number that reflects, from the perspective of the community, a relative compatibility between the community and the staffer based on certain attributes of the community (e.g., services provided) and certain attributes of the potential staff person (e.g., education, training and experience, etc.), along with the community's weighting of those attributes by the communities and the potential staffer persons, respectively. Thus, as between two potential workers, the worker with the higher staff persona score is considered by the community to be “a better match,” for the community, and therefore more likely to accept employment in the selected community and stay longer than the worker who has a lower staff persona score. Therefore, a staff persona score may be thought of as a numerical representation of the likelihood that a particular staff person will accept a job offer for a community and stay there for a longer period of time.

Persona scores are usually unidirectional; meaning that a senior persona score for a senior (viewed from the perspective of a community) may be completely unrelated to and disconnected from the community persona score for that same community (as viewed from the perspective of the senior). Demographic attributes, such as religious affiliation, average net worth, and even the percentage of unmarried persons of the opposite sex, for instance, and non-demographic attributes, such as location, weather, recreational activities, or local restaurants, could have a significant impact on a community persona score viewed from the perspective of a senior, depending on how that senior weighs these attributes. Similarly, senior attributes, such as marital status, net worth, medical condition and hobbies, could have significant impact on a senior persona score viewed from the perspective of a community, depending on how that community weighs these attributes.

Weighting Demographic Qualifiers, Trait Qualifiers and Event Qualifiers.

The demographic qualifiers, trait qualifiers and event qualifiers used by the system to calculate community persona scores, senior persona scores and staff persona scores may be influenced by “weights.” These weights may comprise, for example, a set of arbitrary values, a set of multipliers, a set of rules for calculating a set of values or multipliers, or any combination thereof. The weights (or weighting rules) may be supplied by the senior living community using the system to identify, match and score leads to seniors or staffers (modes of operation 1 and 3), or supplied by a senior or a potential staff person using the system to match and score senior living communities (modes of operation 2 and 4). The weights may also be supplied by a third party, such as a system operator or consultant, who has developed through experience and training special knowledge and expertise in identifying and selecting the best senior and staff candidates for senior living communities, or identifying and selecting the best senior living community candidates for seniors and staffers.

Accordingly, the community information dataset may include weights that the senior living community (or system operator or consultant) wishes to assign to certain senior or staffer attributes. These weights are then used by the system to generate the collection of demographic qualifiers, trait qualifiers and event qualifiers for each senior (or staffer), wherein the weights assigned reflect the senior living community's priorities for future senior residents or future staffers. For example, if a senior living community specifies the State of California as a geographic demographic qualifier for a search (meaning candidates who live outside California would not be matched), but the senior living community wants to put a higher priority on marketing its services to senior candidates who live in San Diego, then the senior living community (or system operator or consultant) could assign a greater weight or use a rule or formula that assigns greater weight to the location demographic qualifier if the value of the location demographic qualifier is “San Diego.” Thus, the weight assignment would cause the system to automatically give more points for the demographic qualifier component of the total persona score if the location demographic attribute of the senior candidate being scored is equal to “San Diego.” On the other hand, if the senior candidate being scored lives in Los Angeles, then that senior candidate would get fewer points added to his or her senior persona score for the geographic qualifier. For the trait qualifiers, if a senior living community wants to diversify its resident population by enrolling more minorities, more single women or more military veterans, then the senior living community (or system operator or consultant) might assign greater weights to the race, gender and military trait qualifiers when the values for those trait qualifiers are “black,” “female” and “yes,” respectively, so that the system will automatically give more points to the senior candidates who have these demographic traits. And finally, for the event qualifiers, if the community operator wishes to give special attention to senior candidates who have filled out a registration form on the senior living community's website, then that senior living community operator (or the system operator or consultant) might assign greater weight to the completed registration form event qualifier, so that the system will automatically produce higher scores for the event qualifier component of the senior persona scores for matched senior candidates who have completed the registration form.

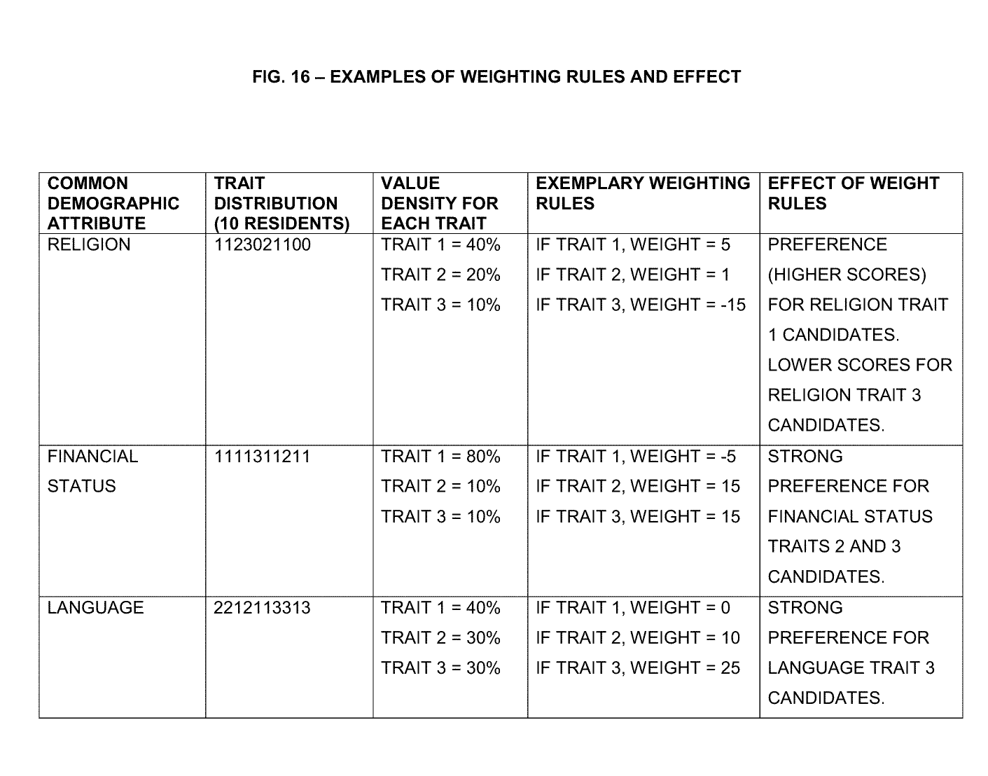

Similarly, the senior dataset and the staffer dataset also may include certain weights that a particular senior or staffer (or system operator) wishes to assign to certain senior living community attributes when the demographic qualifiers, trait qualifiers and event qualifiers for a senior living community have certain values corresponding to the senior's or the staffer's priorities for potential senior living communities. For example, if a particular senior using the system to find a compatible senior living community is a single man living in Florida, who is Jewish, a military veteran, and a musician, and also enjoys swimming, then that senior (or the system operator) might assign greater weight to the community's location attribute when the value for the location attribute is “Florida,” greater weight to the marital status , gender and religion demographic attributes if the values of those attributes are “single,” “female” and “Jewish,” and greater weight to the recreation attribute when the value of the recreation attribute is “swimming pool,” so that the system will automatically calculate higher community persona scores for matched senior living communities having those attributes. Exemplary algorithms for assigning weights to the attributes used for the demographic qualifier, trait qualifier and event qualifier components of the persona scores in accordance with one implementation of the present invention are described in considerably more detail in the discussions of FIGS. 16 through 21 below.

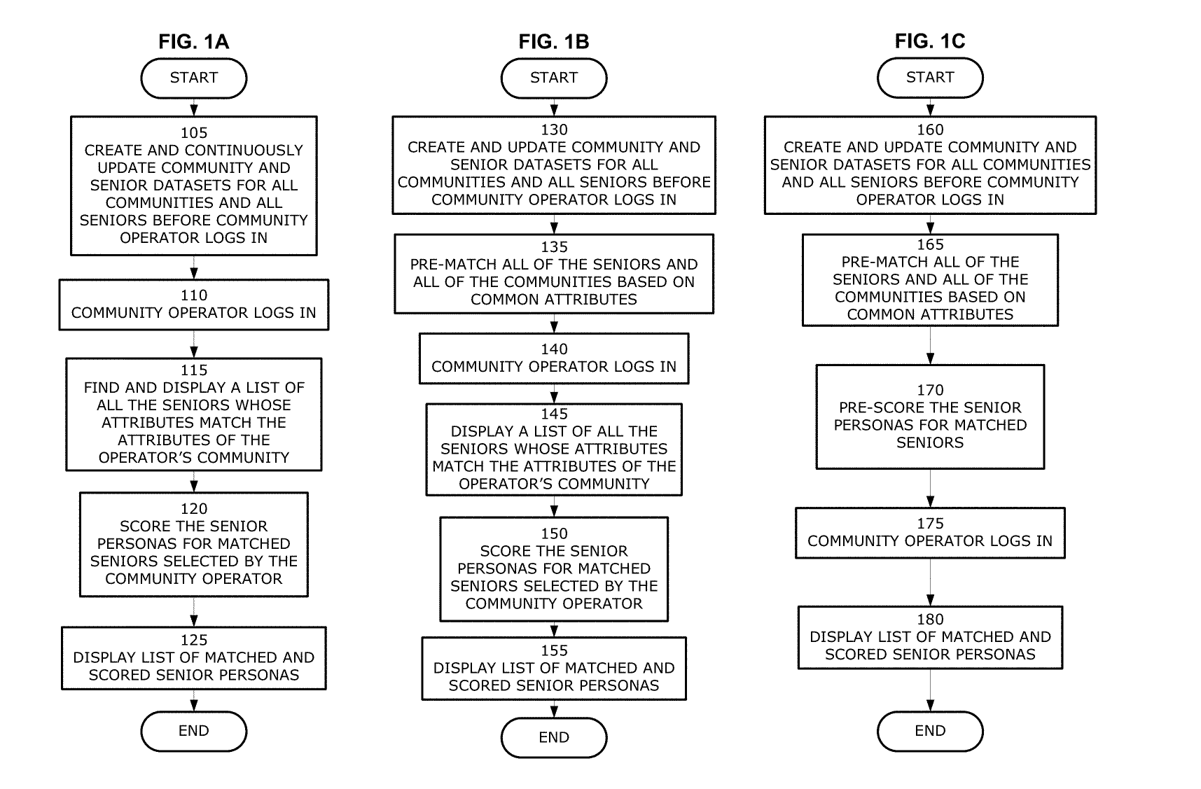

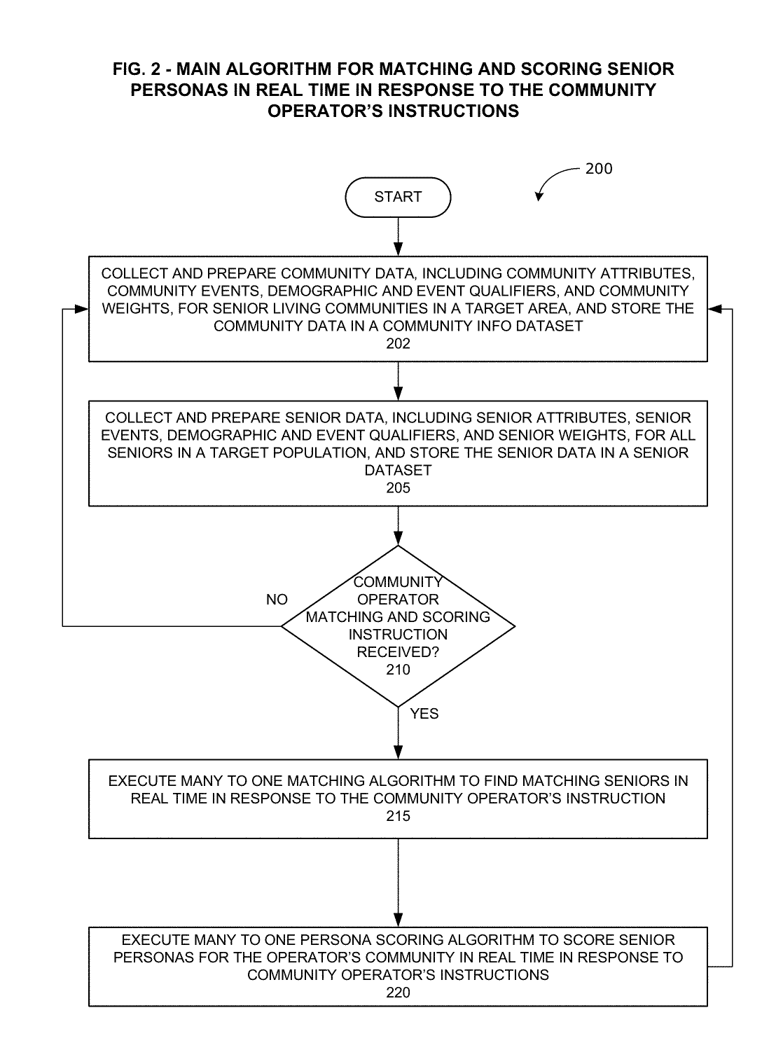

Turning now to the figures, FIGS. 1A, 1B and 1C show three different flow diagrams illustrating by way of example three different implementations of the invention. In the first implementation, illustrated by FIG. 1A, no matching or scoring of seniors is carried out before a community operator logs into the system. Rather, the system creates and continuously updates community and senior datasets (at step 105) before a community operator logs in (or at least before an instruction to do any matching is received). At step 110, a community operator logs in and instructs the system to find matches for his or her particular senior living community. At step 115, the system finds all the seniors in the senior dataset whose attributes match the attributes of the senior living community of the community operator and then displays a list of matched seniors to the community operator. Then, if instructed by the community operator, the system scores the senior personas for selected matched seniors and displays a list of matched and scored senior personas to the community operator (at steps 120 and 125). This scenario of matching and scoring after the community operator logs in and instructs the system to do so is described below as “many-to-one” matching and scoring, and is discussed in more detail below by reference to FIGS. 2 through 9.

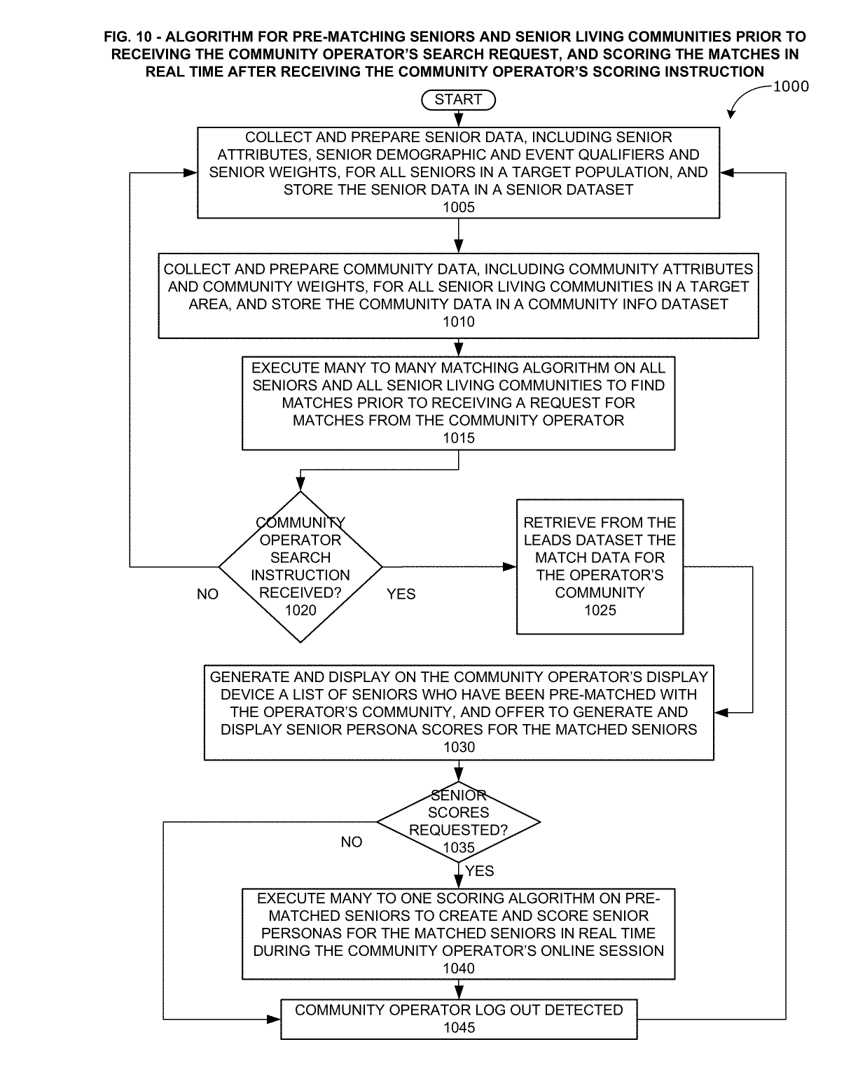

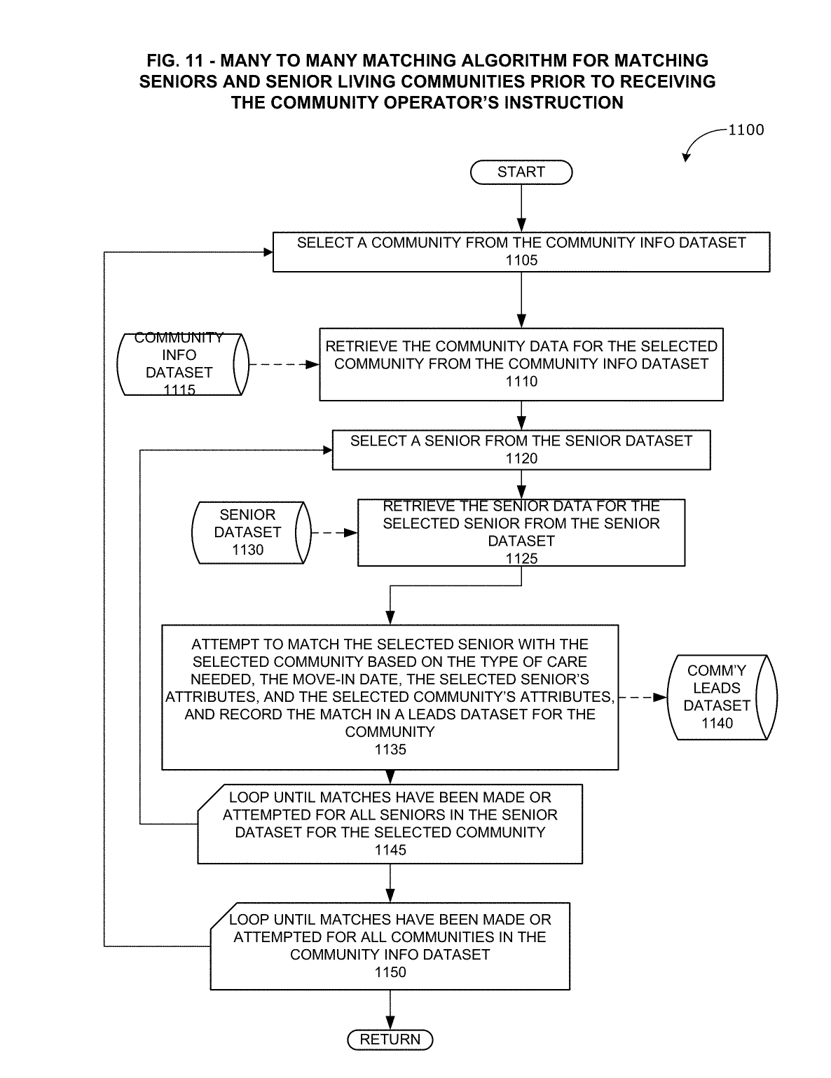

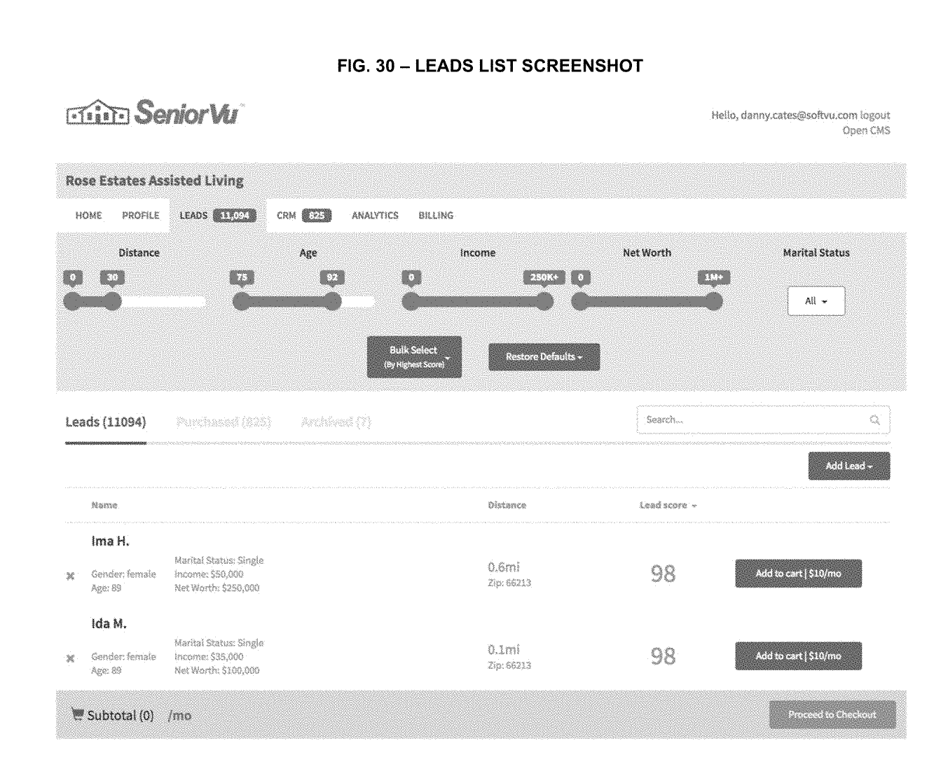

In a second implementation of the invention, illustrated by FIG. 1B, the system still creates and continuously updates the community and senior datasets (at step 135) before a community operator logs in. But in this implementation, the system “pre-matches” all the seniors in the senior dataset with all the communities in the community information dataset based on the common attributes of all the seniors and senior living communities (see step 135 of FIG. 1B). After the community operator logs in at step 140, the system displays senior personas for all the seniors previously determined to match the community operator's particular senior living community (see step 145 of FIG. 1B). If instructed by the community operator to do so, the system scores the senior personas for selected matched seniors (step 150) and displays a list of matched and scored senior personas to the community operator (step 155). Examples of the algorithm steps for carrying out this “pre-matching” implementation of the invention are illustrated in FIGS. 10 and 11 and discussed in detail below. FIG. 30 shows an exemplary screenshot of a list of matched and scored senior personas.

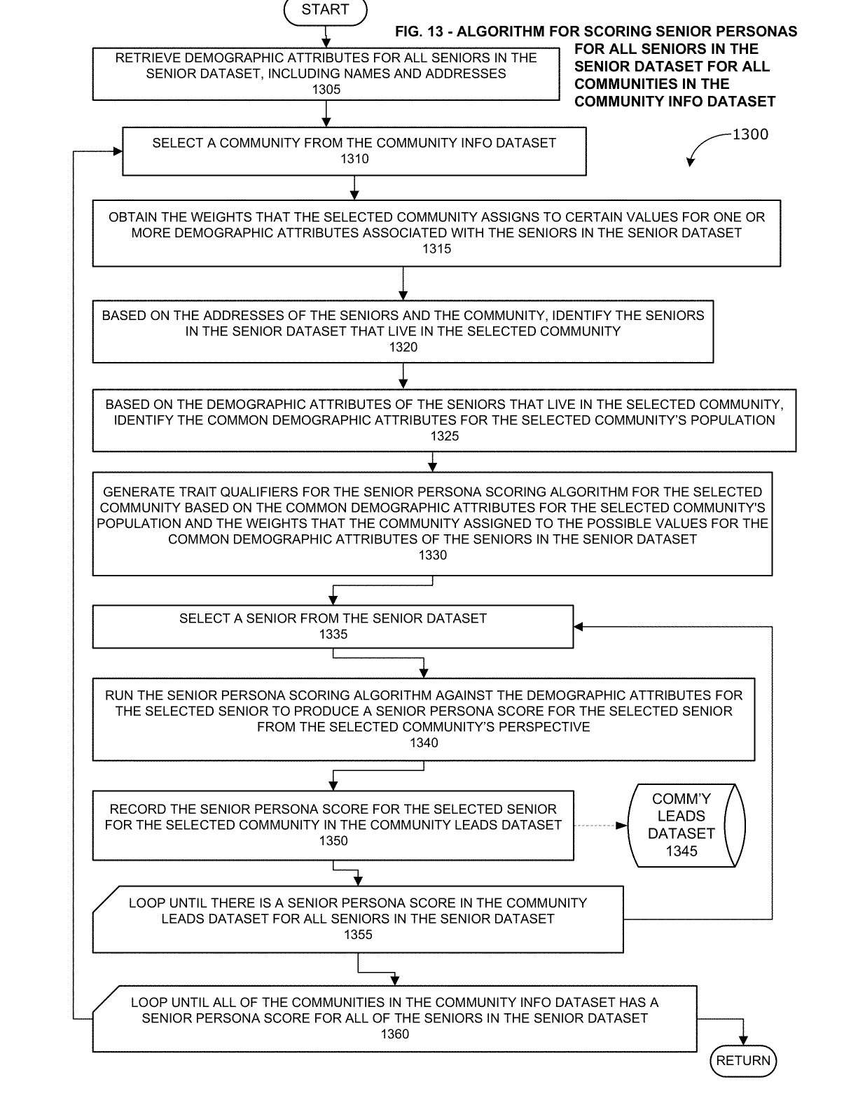

In a third implementation of the invention, illustrated by FIG. 1C, the system still creates and continuously updates the community and senior datasets (at step 160) before a community operator logs in. But in this implementation, the system not only “pre-matches” all the seniors in the senior dataset with all the communities in the community information dataset based on the common attributes of all the seniors and senior living communities (step 165 of FIG. 1C), but also “pre-scores” the senior personas for all the pre-matched seniors and all the senior living communities based on demographic qualifiers, trait qualifiers and event qualifiers in the community information dataset (step 170 of FIG. 1C) before the community operator logs in and instructs the system to do any matching and scoring of senior personas. After the community operator logs in at step 175, the system displays a list of matched and scored senior personas to the community operator (step 180). This implementation is illustrated in the flow diagram depicted in FIG. 13, which is discussed in detail below.

FIG. 2 shows a high-level flow diagram 200 illustrating by way of example the steps performed in a main algorithm of a system for matching and scoring senior personas in real time in response to receiving a community operator's instruction to match and score senior candidates, in accordance with one implementation of the invention. This algorithm 200 is typically carried out for circumstances wherein a senior living community operator is expected to log on and provide inputs or commands that instruct the system to identify and score senior citizen candidates that, based on their persona scores, might be successfully persuaded (with the appropriate marketing efforts and nurturing of leads) to move into the senior living community.

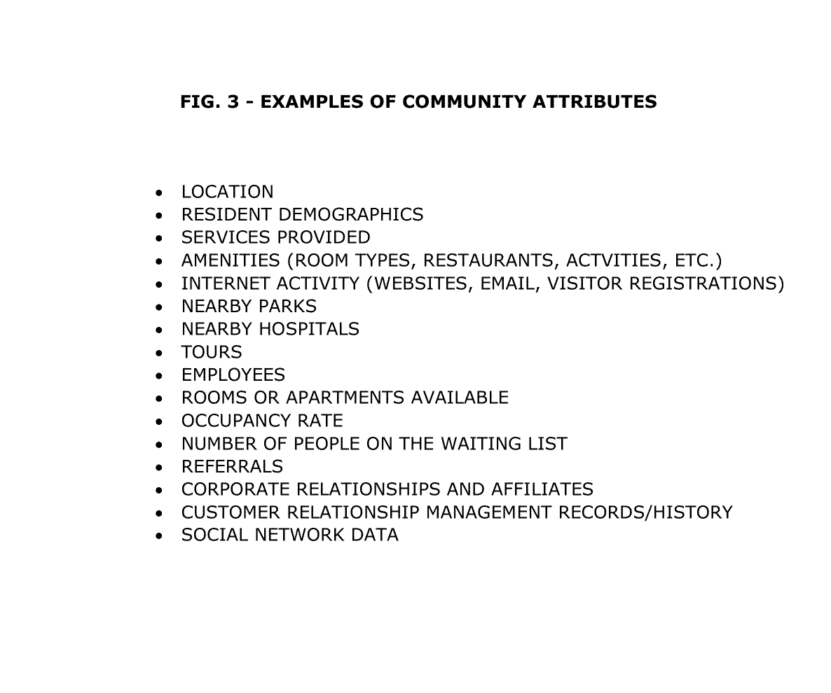

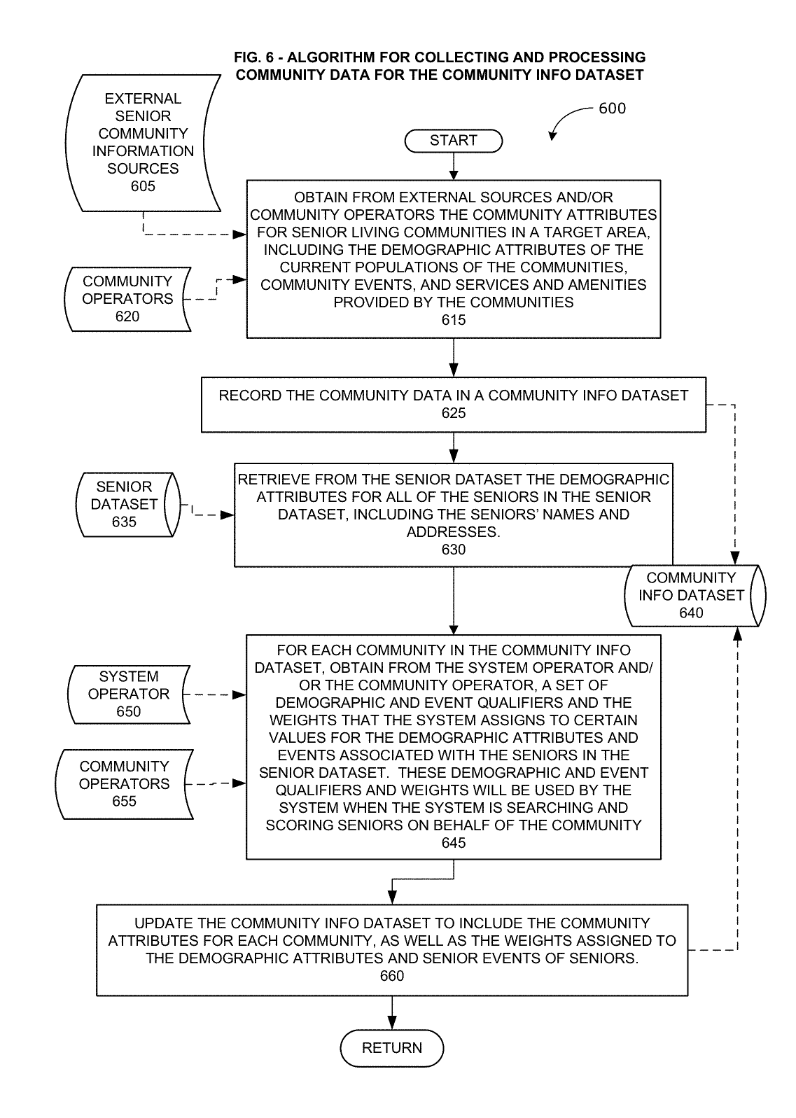

Prior to the community operator logging into the system to search for and score senior candidates, the system, at step 202 of FIG. 2, collects and prepares community data for senior living communities in a target area, and stores the community data in a community information dataset. Some of the community data is collected from external third party sources, and some of the community data is supplied by the community operator when the community operator first signs up and/or registers to use the system, or when the community is otherwise “installed” or set up on the system. The community data includes community attributes, community events, demographic and event qualifiers for the community, and community weights for determining the demographic qualifiers, trait qualifiers and event qualifiers that will be used by the system to calculate the senior persona scores for the seniors. The community attributes may include, for example, the community's location, resident demographics, services and amenities, nearby parks and restaurants, types of rooms and apartments available, etc. Community events may include press releases, reviews by websites, newspapers or magazines, open houses, groundbreaking ceremonies, recommendations by friends and current residents, etc. FIG. 3 shows nonlimiting examples of some of the community attributes and events that may be collected, prepared and stored in the community information dataset in step 202. It will be understood, however, that more or fewer community attributes and events, or different community attributes and events from those shown in FIG. 3, may be selected and used, depending on the particular implementation of the invention. The community demographic qualifiers, event qualifiers and community-specified weights are described in considerably more detail in the discussion of FIG. 6 below.

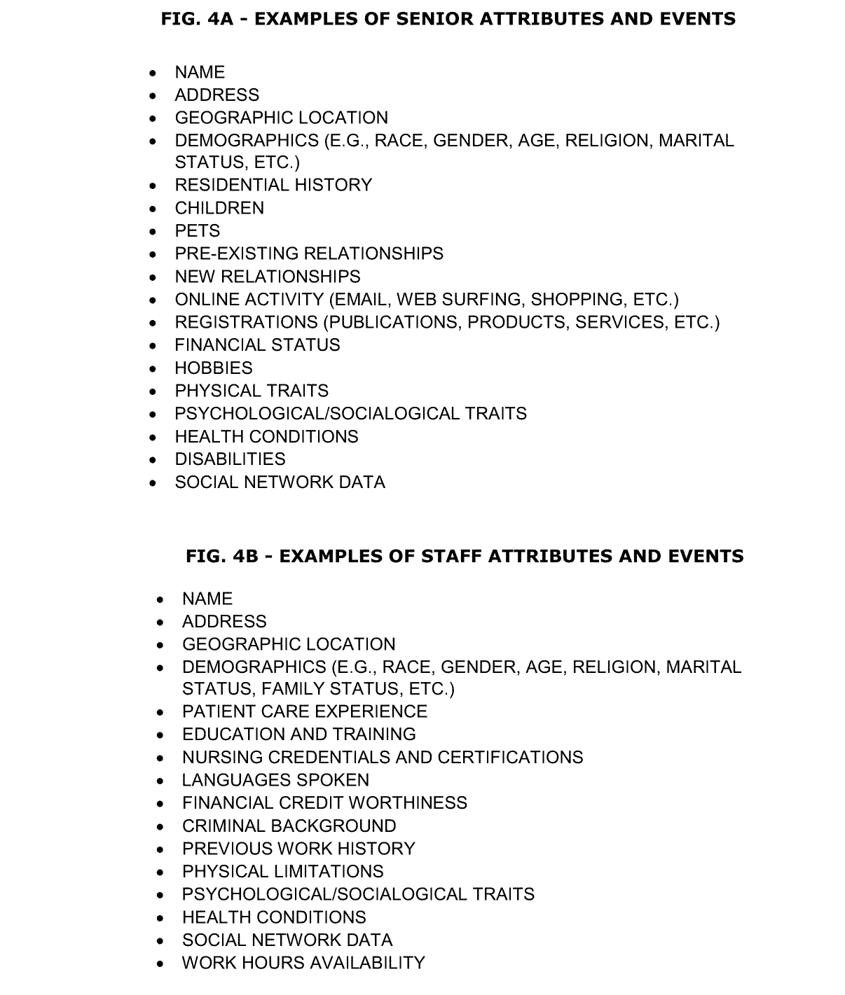

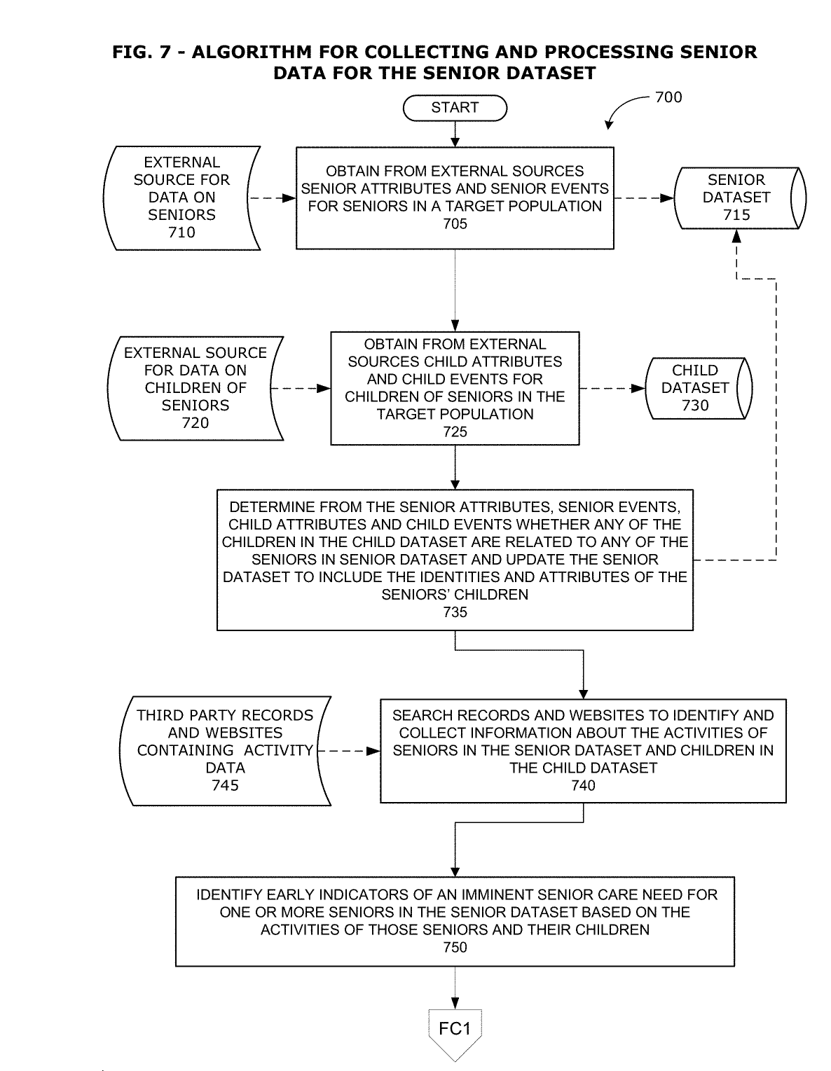

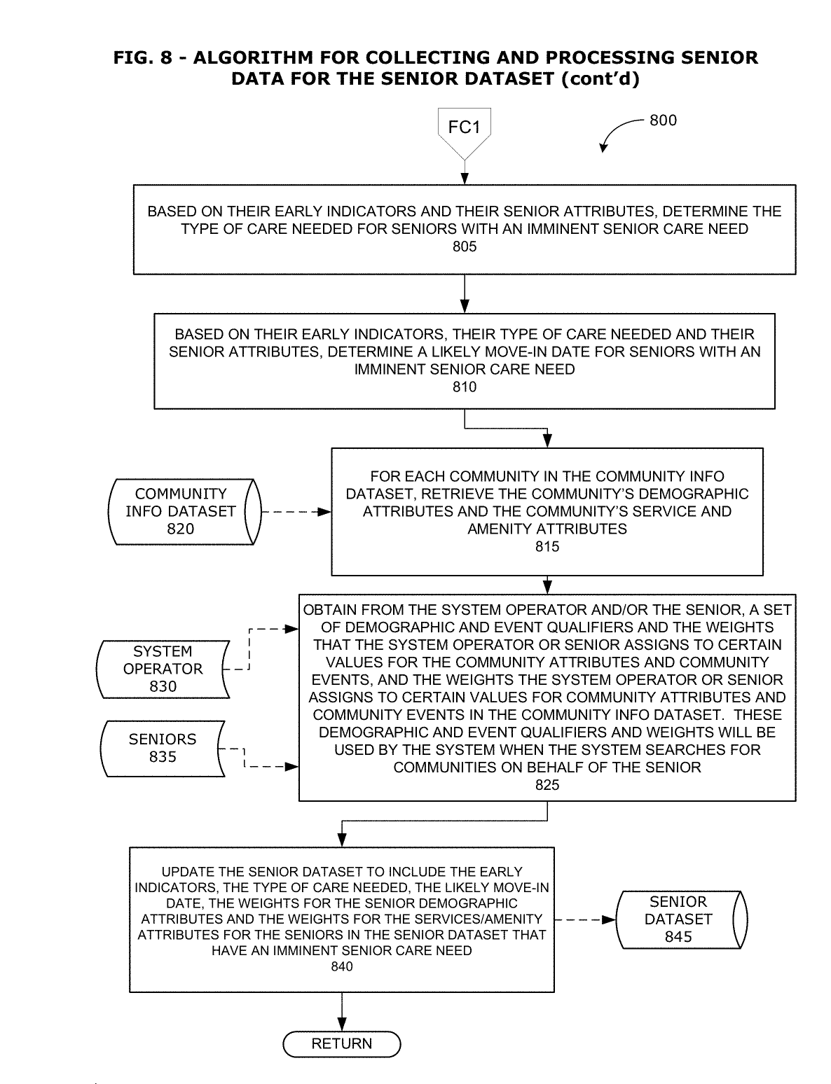

Next, in step 205 of FIG. 2, the system collects and prepares senior data, including senior attributes, senior events, demographic qualifiers, event qualifiers and senior-specified weights, and stores this senior data in a senior dataset. Some of the senior data may be collected from external third party sources, and some may be collected from seniors who have signed up to use the system. FIG. 4A shows nonlimiting examples of some of the senior attributes and senior events that may be collected, prepared and stored in the senior dataset in step 205. As shown in FIG. 4A, the senior attributes may include, for example, seniors' names, addresses, geographic locations, age, gender, marital status, residential history, financial status, health conditions, etc. Senior events may include, for instance, marketing engagement, taking a tour, filling out an online form, or having a spouse pass away. It should also be understood, however, that more or fewer senior attributes and events, or different senior attributes and events from those shown in FIG. 4A, may be selected and used, depending on the particular implementation of the invention. The senior demographic qualifiers and event qualifiers, as well as senior weights, are described in considerably more detail in the discussions for FIGS. 7 and 8 below.

If the system is also configured to identify and score matches between senior living communities and staff candidates, then the main algorithm may also include another step (not shown in FIG. 2), wherein the system collects, prepares stores in a staffing information dataset data about potential staff persons in a target area, including staff attributes. FIG. 4B shows nonlimiting examples of some of the staff attributes that may be collected, prepared and stored in the staffing information dataset. As shown in FIG. 4B, the staff attributes collected from staff candidates and stored in the staff dataset (as part of step 205) may include, for example, the names, addresses, geographic locations, demographics, work history, experience, education, training, financial status, physical limitations of each staff candidate. It should also be understood, however, that more or fewer staff attributes, or different staff attributes from those shown in FIG. 4B, may be selected and used, depending on the particular implementation of the invention.

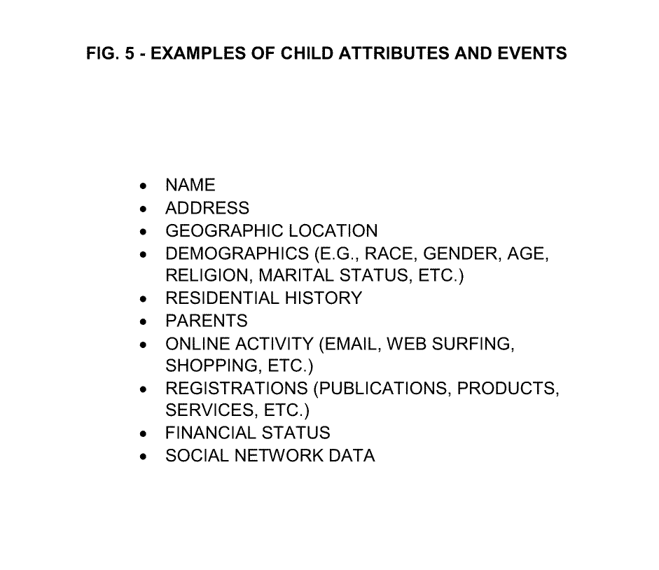

Notably, the system may also be configured to collect, prepare and store in a child dataset the attributes for the children of seniors in a target area, including, for example, their children's names, addresses, geographic locations, demographics, residential history, parents' names and financial statuses. FIG. 5 contains additional examples of child attributes and child events. Collecting and storing child attribute data can be important and very useful for purposes of identifying, scoring matching senior personas because it is frequently the child of a senior candidate, and not the senior candidate herself, who is actively researching, visiting and/or touring senior living communities on behalf of their aging parents. Moreover, it is often the child of a senior resident, and not the senior resident herself, who plans to pay all of the charges incurred for the care provided to the senior resident by the senior living community. Therefore, it is sometimes necessary or desirable to consider factors such as the child's financial status, the child's responses to advertisements, or the distance between the child's home and the senior living community.

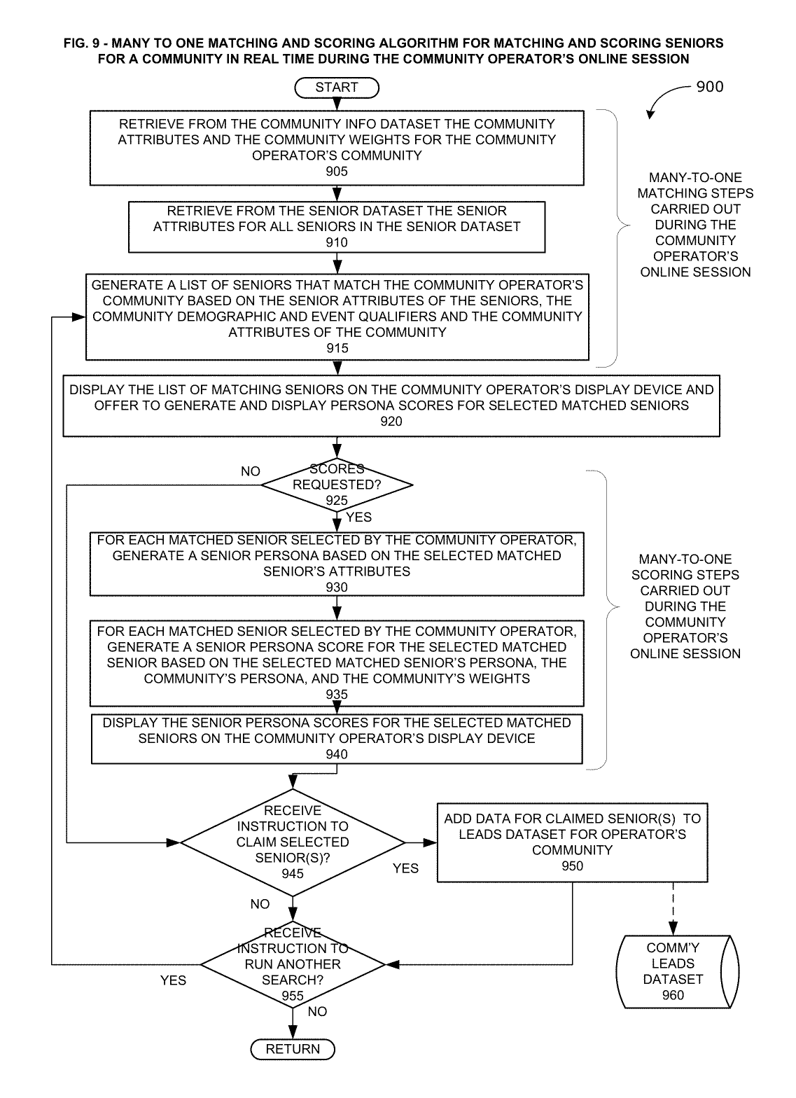

Returning now to FIG. 2, at step 210, the system checks to determine whether the community operator has instructed the system to match, score and display senior candidates for the senior living community. If the answer is no, then the system continuously loops back through steps 202, 205 and 210 to repetitively collect, prepare and store new community and new senior data in the community information dataset and the senior dataset, respectively, as the new senior data and new community data become available. Thus, the loop defined by steps 202, 205 and 210 in FIG. 2 serve to keep the community information dataset, senior dataset and, if applicable, the staffing information dataset, up-to-date with the latest information about the senior living communities, the seniors and the staff persons (if applicable) in the target area. On the other hand, if it is determined at step 210 that the community operator has instructed the system to match and score seniors (the instruction may be provided, for example, by the community operator clicking on a button or icon displayed on the community operator's display device), then the system executes, at step 215 of FIG. 2, a many-to-one matching algorithm to find and display in real time matching seniors for the senior living community. (See the many -to-one matching steps depicted in the top half of the algorithm shown in FIG. 9 and described in more detail below). After a collection of matching seniors are found and displayed by the system, the system next proceeds to step 220 of FIG. 2, wherein the system executes in real time a many-to-one senior persona scoring algorithm, which displays the senior persona scores for each matched senior. (See the many -to-one scoring steps depicted in the bottom half of the algorithm shown in FIG. 9 and described in more detail below) to score the senior personas for the community operator's senior living community. At this point, the system may be configured, as shown in FIG. 2, to return to step 202 and again execute the loop defined by steps 202, 205 and 210 to update the community information dataset and the senior dataset with the latest community and the latest senior data obtained from external sources, community operators, seniors, or all of them.

As previously stated, embodiments of the present invention may also be used to match staff candidates in a target area (instead of senior candidates) with senior living communities.

In these situations, the system performs substantially the same steps as shown in FIG. 2, except that the data collection and matching steps of 205, 215 and 220 are performed on a staffing information dataset for staff candidates, instead of being performed against a senior dataset for seniors. In other words, instead of collecting, preparing and storing senior data in a senior dataset, and executing many-to-one matching and scoring algorithms to match and score seniors on behalf of the senior living community, the system collects, prepares and stores staff data in a staffing information dataset, and executes substantially the same matching and scoring algorithms to match and score staff personas for the community. The staff data collected by the system may also include staff demographic qualifiers and staff event qualifiers, as well as staff weights, which would be processed by the system in substantially the same manner that the senior demographic qualifiers, the senior event qualifiers and the senior weights are processed by the system, as described in the discussions for FIGS. 7, 8 and 9 below.

FIG. 6 shows a high-level flow diagram 600 illustrating by way of example the steps performed in an algorithm for collecting, processing and storing community data in the community information dataset, in accordance with one implementation of the present invention. Typically, although not necessarily, this algorithm will be called up and executed as a result of performing step 202 in FIG. 2. First, in step 615, the system obtains from external sources 605 and community operators 620 a collection of community attributes for senior living communities in a target area, the community attributes including the demographic attributes of the current populations of the communities, and the services and amenities provided by the communities. The external sources may include, for example, both public and private datasets that license applications and building permits filed by new senior living communities, datasets that track special events affecting seniors, special events affecting children of seniors, general community events, third party web sites (e.g., retirement and estate planning services), etc. The community data may also be obtained by utilizing web crawlers and website scrapers configured to identify and collect information from the Internet indicating that a senior or a child of a senior may soon be seeking senior care for herself or a parent (early indicators). In step 625, the data collected from the external sources 605 and community operators 620 are stored in the community information dataset 640.

In step 630, the system retrieves from the senior dataset 635 demographic attributes for all the seniors in the senior dataset 635, including the seniors' names and addresses. At step 645, for each community in the community information dataset, the system obtains from the system operator 650 and/or community operator 655 a set of demographic qualifiers and a set of event qualifiers. The system also receives weights (or a set of weighting rules) that the system will use for assigning values to certain components of the demographic qualifiers, trait qualifiers and event qualifiers during the calculation of the senior persona scores. At step 660, the community attributes for each community, as well as the weights for the one or more demographic attributes of seniors, are stored in the community information dataset 640. After executing step 660, processing returns to step 205 in FIG. 2.

The demographic qualifiers for a community include qualifications that the community operator (or, in some cases, the system operator) wishes to impose on the search results for the matching system so that seniors who have those qualifications will be determined by the system to be a match for the senior living community, and seniors who do not meet those qualifications will not be determined by the system to be a match for the senior living community. For example, if the senior living community operator wants to exclude from the search results all of the senior candidates who are located outside of the State of California, then the senior living community operator can specify that being located inside the State of California is a demographic qualifier for the matching algorithm. As a result, any senior candidate found in the dataset who lives outside of the State of California will be excluded from the search results and will not have their senior personas scored and presented to the senior living community operator. Other attributes that could be used as demographic qualifiers for the matching might include, for example, the type of care required by the senior, the senior's age or credit score, the senior's gender, or whether or not the senior has a pet. Typically, each senior living community operator will supply a plurality of demographic qualifiers for the matching system, all of which will be used by the matching system to determine whether or not a particular senior in the senior dataset qualifies as a match.

Event qualifiers for a community are a separate and distinct category of qualifications that the community operator may wish to impose on the search results for the matching system. Event qualifiers are typically used to include or exclude from the matching results candidates who have (or have not) performed some action indicating or suggesting that they are interested (or not interested) in the senior living care community. Such acts may include, for example, calling or visiting the senior living community's physical facility, registering or filling out a form on the senior living community's website, or responding to a direct mail advertisement from the senior living community. Negative actions, such as failing to respond to a telephone call or invitation to tour the facility, or rejecting an offer to meet with a representative from the senior living community, may also be identified by the senior living community operator as an event qualifier for matching purposes. Event qualifiers may also include passive actions, such as having a spouse pass away. Typically, each senior living community operator will supply a plurality of event qualifiers for the matching system, which will be used by the matching system to determine whether or not a particular senior in the senior dataset qualifies as a match.

Trait qualifiers for a community are a third category of qualifications that the senior living community operator may wish to impose on the search results for the matching system. Trait qualifiers are typically used to include or exclude from the matching results candidates who have (or do not have) certain demographic traits, such as gender, race, religion, marital status, financial condition, church affiliation, etc. Receiving one or more trait qualifiers from the senior living community operator prior to running the matching algorithm allows the system to include in the search results certain groups of people (e.g., singles, veterans, minorities, etc.) that the senior living community thinks are currently underrepresented in the community, or certain groups of people who, because of their religion, might be particularly interested in the senior living community. Typically, each senior living community operator will supply a plurality of event qualifiers for the matching system, all of which will be used by the matching system to determine whether or not a particular senior in the senior dataset qualifies as a match.

To help the community operator prioritize the collection of candidates determined by the system to match all of the senior living community's specified demographic qualifiers, trait qualifiers and event qualifiers, the collection of candidates returned from the matching step need to be scored (i.e., ranked). For this reason, in step 645, the system also receives from the senior living community operator 650 a set of weights (or weighting rules). These weights or rules may also be supplied by a third party, such as a consultant (not shown in FIG. 6), who has special knowledge or expertise in identifying and selecting the best seniors for senior living communities, or identifying and selecting the seniors most likely to respond to particular types of marketing campaigns. The weights are used by the system to influence the relative values (or the number of points) added to the persona scores of each matched senior candidate for certain demographic attributes (e.g., gender, race, religious affiliation, financial condition, etc.) associated with the candidate. A senior living community may decide, for example, that a candidate who is not married should get five extra points added to his or her senior persona score, a candidate who is a military veteran should get ten extra points added to his or her senior persona score, and a candidate with a high net worth should get twenty extra points added to his or her senior persona score. Under these circumstances, the senior living community operator would supply the system with weights of 5, 10 and 20 points in step 645 of FIG. 6. The community attributes and the weights received in step 645 are stored in the community information dataset at step 660 of FIG. 6. Control then returns back to step 205 of the main algorithm shown in FIG. 2.

FIGS. 7 and 8 show a high-level flow diagram 700 illustrating by way of example the steps performed in an algorithm for collecting and processing senior data for the senior dataset 715. First, at step 705, the system obtains from external sources 710 the senior attributes of seniors in a target population. FIG. 4A contains a non-exclusive list of exemplary senior attributes that could be collected and processed in this step. The target population may comprise a neighborhood, community, city, county, state, country, region of the world, or some combination thereof. Next, in step 725, the system obtains from external sources 720 the child attributes of seniors in the target population and stores those attributes in the child dataset 730. In step 735, the system cross-references the data in the senior dataset with the data in the child dataset to determine from the senior attributes and the children attributes whether any of the children in the child dataset are related to any of the seniors in the senior dataset, and if so, the system updates the senior dataset to include the identities, relationships and attributes of the seniors' children. At step 740, the system searches electronic records, publications and websites 745 to identify and collect information about the activities of seniors in the senior dataset 715 and children in the child dataset 730. Based on the available information, the system identifies, in step 750, early indicators of imminent senior care need for one or more seniors in the senior dataset 715. As previously stated, early indicators of imminent senior care need may be found in home sales records, motor vehicle records, walker and wheelchair purchase records, obituaries and census records, just to name a few examples.

Control then passes to step 805 of the flowchart 800 shown in FIG. 8 by way of flow chart connector FC1, where the system determines, based on the early indicators, the type of care needed for a senior with an imminent senior care need. The types of senior care may include, without limitation, assisted living, skilled nursing care, memory care (for Alzheimer and dementia patients), independent living care and in-home care. In step 810, using historical data on previous move-in dates and historical data on the early indicators associated with those previous move-ins, the system analyzes the current early indicators, the types of care needed and the senior attributes of the seniors to determine likely move-in dates for seniors who are just now producing early indicators of imminent senior care need. The likely move-in dates are stored in the senior dataset 845, along with the other senior attributes.

Next, at step 815, the system retrieves for each community in the community information dataset 820 the community's demographic attributes and the community's service and amenity attributes. In step 825, the system obtains from the system operator 830 and/or the senior 835 a set of demographic and event qualifiers and the weights that the system operator 830 or the senior 835 assigns to certain values for the senior demographic attributes, and the weights the system operator 830 or senior 835 assigns to the services and amenities attributes of the communities in the community's information dataset 820. These demographic and event qualifiers and weights will be used by the system when the system searches for communities on behalf of the senior. In step 840, the system updates the senior dataset 845 to include the early indicators, the type of care needed, the likely move-in date, the weights for the senior demographic attributes and the weights for the services and amenity attributes for the seniors in the senior dataset that have an imminent senior care need. Control then returns to step 210 in FIG. 2.

FIG. 9 shows a high-level flow diagram 900 illustrating by way of example the steps performed in an algorithm for matching and scoring seniors for a community in real time during an operator's online session, in accordance with one implementation of the invention. In this example, the matching and scoring is carried out on a many-to-one basis—meaning that the system analyzes and compares the attributes of a single senior living community to the attributes of many seniors (all of the seniors in the senior dataset) to generate and present to the single senior living community a list of many seniors (and their persona scores) for that single senior living community. First, in step 905, the system retrieves from the community information dataset the attributes and the community weights for the current operator's senior living community. At step 910, the system retrieves from the senior dataset the senior attributes for all of the seniors in the senior dataset. Next, in step 915, the system generates a list of seniors that match the community operator's community based on the senior attributes of the seniors, the community demographic and event qualifiers and the community attributes (i.e., the services and amenities of the community). A senior may be considered to be a match, for example, if the senior's attributes match the demographic qualifiers (e.g., location=California, and type of care needed=memory care) and the event qualifiers (e.g., walk-in visitor=yes) supplied by the senior living community.

The system then displays a list of matching seniors on the community operator's display device (which could be a computer monitor, a tablet screen or a smartphone display screen) and offers to generate and display persona scores for any of the matched seniors selected by the community operator. (Step 920). At step 925, the system determines whether the community operator elected to have the senior persona scores of the matched seniors displayed. If the community operator does not opt to see the persona scores of any of the matched seniors, then control passes to step 945 of FIG. 9, wherein the system determines whether the community operator provided an instruction to claim any of the matched seniors. In this example, claiming a matched senior may mean the community operator has elected to purchase additional information about the matched senior in order to initiate targeted marketing for that senior. In this case, claiming the matched senior causes the system to copy the senior attributes for the selected matched senior into the leads dataset 960. See step 950. In some embodiments, claiming a senior may also cause the system to automatically create and send targeted marketing materials to the claimed senior.

If, on the other hand, it is determined at step 925 that the community operator wishes to have one or more of the matched seniors' persona scores displayed, then in step 930 the system next generates a senior persona for each matched senior selected based on the senior attributes of the selected matched senior. A senior persona for a selected senior is a collection of attributes and attribute values associated with the selected senior. For example, senior citizen John Doe's senior persona may comprise multiple attributes and values for those attributes, such as: race=“white,” gender=“male,” religion=“catholic,” marital status=“married,” income=“$68,000,” military veteran=“no,” and college graduate=“yes.” Generating the senior persona may comprise retrieving the senior attributes for the selected matched senior and the values of the senior attributes from the senior dataset and placing those values in a temporary array or other memory structure in preparation to run those attributes and values through the persona scoring algorithm for the community. The senior persona data may also be properly formatted and transmitted for display on a display device or computer system operated or controlled by the senior living community. FIG. 30 contains an exemplary screenshot of a displayed list of senior personas that might be used with embodiments of the present invention.

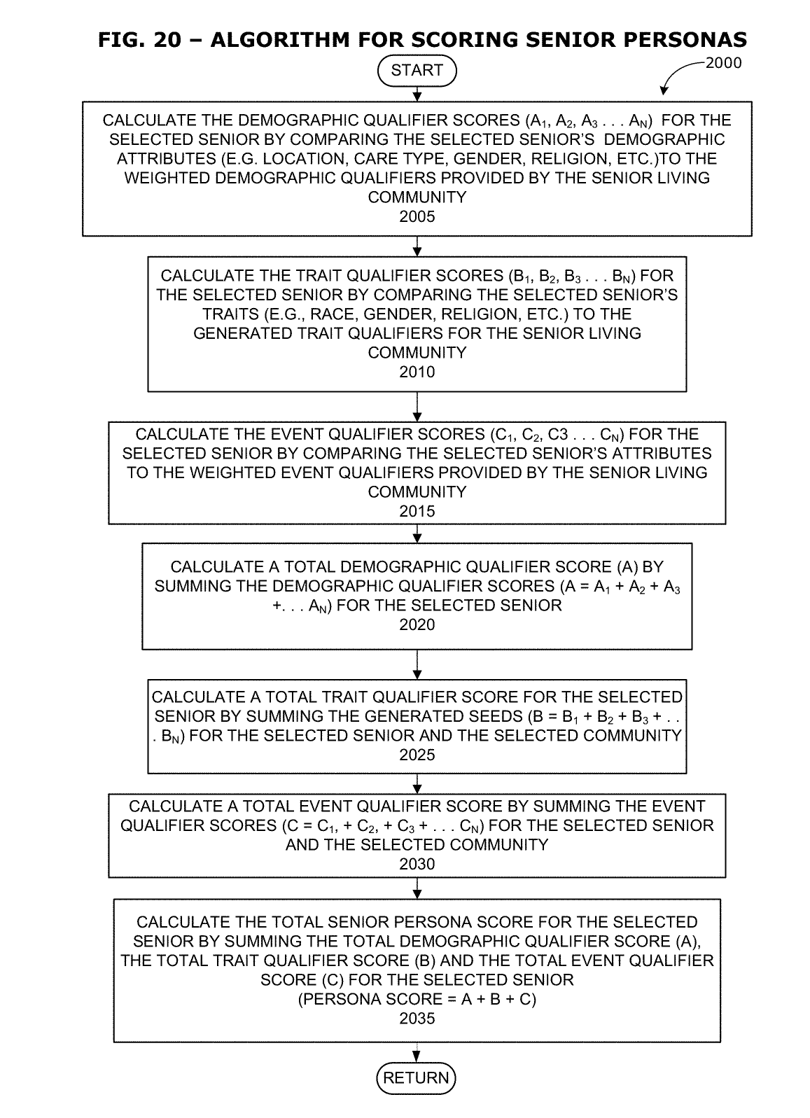

Next, at step 935, for each matched senior selected by the community operator, the system generates a senior persona score based on the selected matched senior's persona, the community's persona and the community's weights. The algorithm for generating the senior persona scores is shown in FIG. 20, which is discussed in more detail below. The senior persona scores for all the selected matched seniors are then displayed on the community operator's display device in step 940. Then the system permits the community operator to claim one or more selected seniors (step 945), run another search (step 955) or return control to step 202 of the main algorithm shown in FIG. 2.

FIG. 10 shows a high-level flow diagram illustrating by way of example the steps performed in an algorithm 1000 for pre-matching seniors and senior living communities prior to receiving the community operator's search request, and then scoring the senior personas for the matched seniors in real time after receiving the community operator's scoring instruction according to an implementation of the invention. At step 1005, the system collects and prepares senior data, including senior attributes, senior demographic and event qualifiers and senior weights, for seniors in a target population, and stores the senior data in a senior dataset. Then, at step 1010, the system collects and prepares community data, including community attributes and community weights, for senior living communities in a target area, and stores the community data in the community information dataset. Notably, the target population and the target area may not be the same geographic area. Next, at step 1015, the system executes a many-to-many matching algorithm on all seniors and all senior living communities to match all the seniors with all the senior living communities based on the senior personas, the community personas, the attributes of the seniors and the attributes of the senior living communities. The matched senior information is typically stored in a leads dataset. The algorithm the system uses for the pre-matching is illustrated in FIG. 11 and discussed in more detail below. Notably, this pre-matching of seniors and senior living communities occurs before the community operator logs on or instructs the system to do any scoring of senior personas.

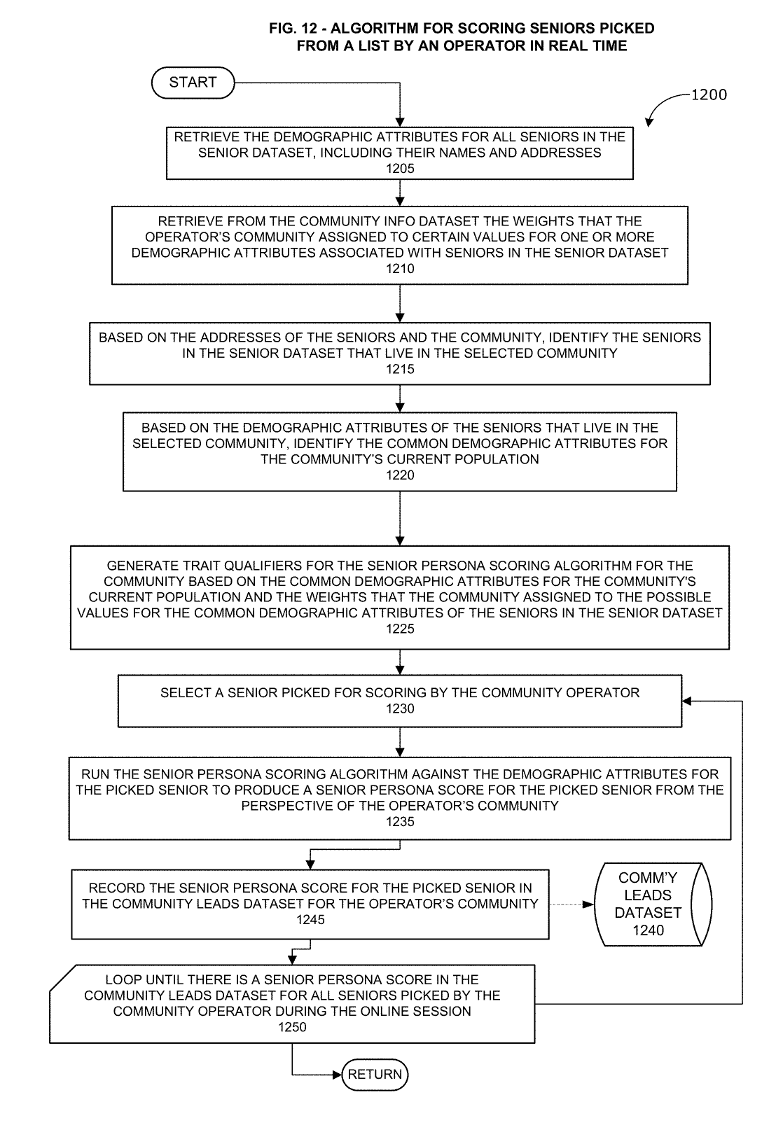

At step 1020, the system determines whether a community operator has provided an instruction to search the datasets for matches. If not, then the system again executes the steps defined by the loop of 1005, 1010, 1015 and 1020, whereby the system repeatedly collects the latest up-to-date information about the seniors in the target population and the senior living communities in the target area and updates the datasets. However, if the community operator does instruct the system to show search results, then the system retrieves the match data from the leads dataset and displays it on the display device of the community operator (see steps 1025 and 1030 of FIG. 10). The system next determines, at step 1035, whether the community operator gave an instruction to score the senior personas of the matched seniors and display the scored personas. If the answer is no, the system logs the community out (step 1045) and starts the process all over again at step 1005. If, however, the answer is yes, then the system executes a many-to-one scoring algorithm on the pre-matched seniors to create and score senior personas for the matched seniors in real time (see step 1040). The many-to-one scoring algorithm is illustrated in FIG. 12, which is discussed in more detail below.

FIG. 11 shows a high-level flow diagram 1100 illustrating by way of example the steps performed in an algorithm for matching seniors and senior living communities prior to receiving the community operator's search instruction. In this implementation of the invention, the matching is carried out on a many-to-many basis, meaning that matches are made or attempted for all of the seniors and all of the senior living communities. As shown in FIG. 11, the system first selects a community from the community information dataset (step 1105) and retrieves from the community information dataset 1115 the community data for the selected community (step 1110). Then the system selects a particular senior from the senior dataset 1130, retrieves the senior data for the selected senior from the senior dataset 1130 and attempts to match the selected senior with the selected community based on the type of care needed, the move-in date, the selected senior's attributes, and the selected community's attributes (steps 1120, 1125 and 1135). Matching information is then stored in the leads dataset 1140. The system then loops through the steps defined by steps 1120 to 1145 until matches have been made or attempted for all seniors in the selected senior living community. When matches have been made or attempted for all seniors in the senior dataset for the selected community, then control passes back to step 1005 to select the next senior living community from the community information dataset 1115 and begin the process of matching or attempting to match all of the seniors in the senior dataset 1130 for the selected community. In this manner, the system will loop through all the steps in FIG. 11 until matches have been made or attempted for all communities in the community information dataset (step 1150).

FIG. 12 shows a high-level flow diagram illustrating by way of example the steps performed in an algorithm for scoring senior personas in real time for seniors. Typically, but not necessarily, this algorithm is invoked in response to a community selecting certain seniors from a list of matched seniors to instruct the system to score and/or rank those matched seniors based on the attributes of the selected seniors, as well as weights supplied by the community operator for certain demographic attributes of the senior living community's current population. Beginning at step 1205, the system first retrieves from the senior dataset demographic attributes for all seniors, including their names and addresses. Then the system retrieves from the community dataset the weights that the operator's community assigned to certain values for one or more demographic attributes associated with seniors in the senior dataset (step 1210). The weights may be arbitrary values, multipliers or some combination of arbitrary values and multipliers. Based on the addresses of the seniors and the community, in step 1215, the system identifies the seniors in the senior dataset that live in the selected community.

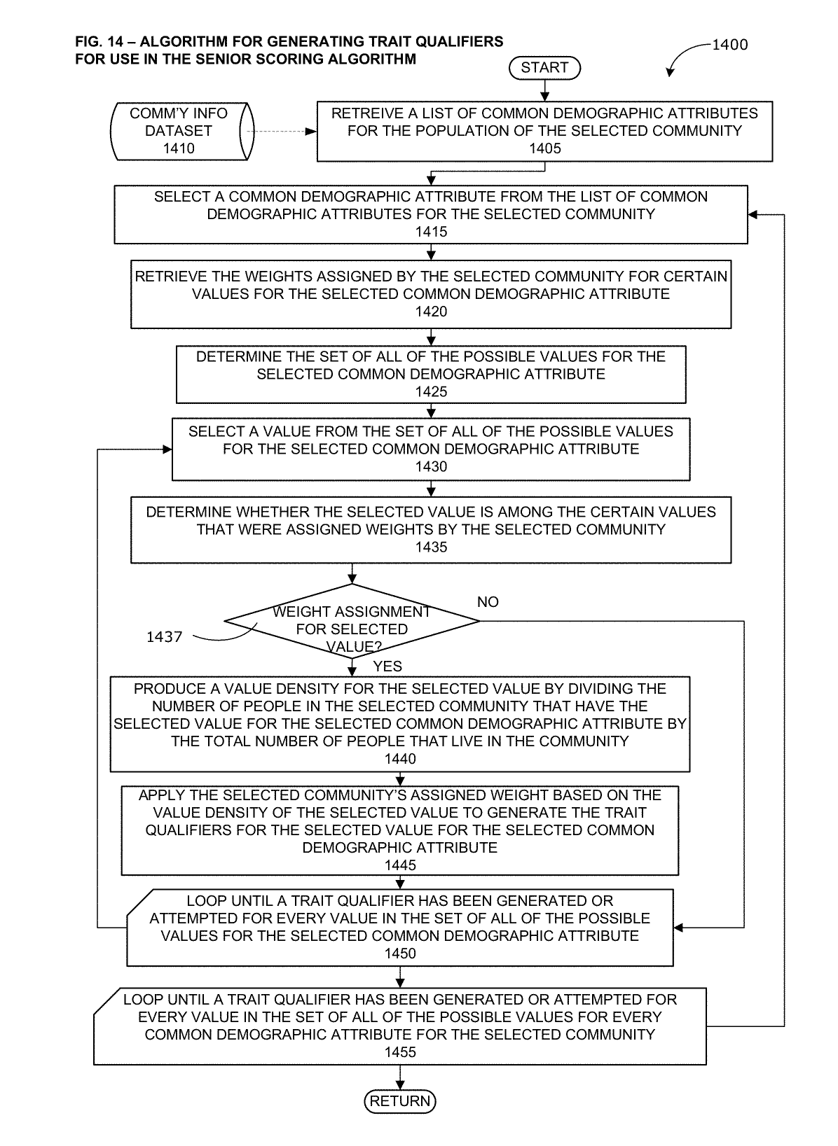

In step 1220, the system identifies common demographic attributes for the selected community's current population. For example, if 55 out of 100 residents of a senior living community are female, then those 55 residents share (or have in common) the female trait for the gender demographic attribute for that community. So a common demographic attribute that might be identified in step 1220 of FIG. 12 is gender. Other common demographic attributes that could be identified in step 1220 for a given community might include, for example, age, race, financial status, religion, etc. In step 1225, the system generates trait qualifiers for the senior persona scoring algorithm for the community based on the common demographic attributes for the community's current population and the weights that the community assigned to the possible values for the common demographic attributes of the seniors in the senior dataset. FIG. 14, which is described in more detail below, illustrates an algorithm for generating the trait qualifiers in accordance with an embodiment of the invention. In steps 1230 and 1235, the system selects a senior picked for scoring by the community operator, and then runs the senior persona scoring algorithm to produce a senior persona score for the picked senior from the perspective of the senior living community of the community operator. FIG. 20, which is described in more detail below, illustrates an example of the senior persona scoring algorithm that could be run in step 1235 of FIG. 12. At step 1245, the senior persona scores produced in step 1235 are stored in the community leads dataset 1240. The system then executes the loop defined by steps 1230, 1235, 1245 and 1250 until there is a senior persona score in the community leads dataset for all seniors picked by the community operator during the online session. When a senior persona score has been produced for all the seniors selected by the community operator, control then passes back to step 940 of the algorithm shown in FIG. 9.

While the algorithm of FIG. 12 illustrates the logic associated with scoring the senior personas of all of the seniors selected by the community operator, it will sometimes be necessary or desirable to score the senior personas for all the seniors in the senior dataset for all the communities in the community information dataset, regardless of the selection of senior personas for scoring by the community operator. FIG. 13 shows a high-level flow diagram illustrating by way of example the steps performed in an algorithm for scoring senior personas for all seniors in the senior dataset for all communities in the community information dataset. The steps executed in the algorithm of FIG. 13 are substantially the same as the steps executed in the algorithm of FIG. 12, except that additional programming loops are added to ensure that the senior persona scoring steps (including invoking the algorithm to produce the persona score) are repeated until there is a senior persona score in the senior dataset for all the seniors in the senior dataset and all the communities in the community information dataset have a senior persona score for all of the seniors. (See the loop defined by steps 1360 and 1310).

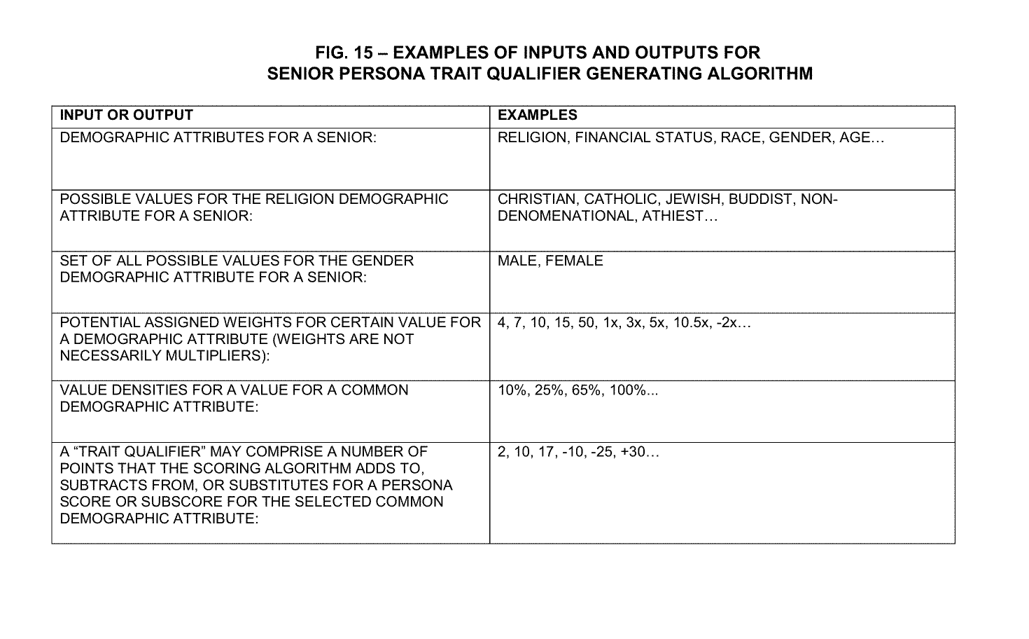

In step 1225 of FIG. 12 and step 1330 of FIG. 13, the system generates trait qualifiers to be used in a senior persona scoring algorithm for the selected senior living community. After these trait qualifiers are generated, they are used as “seeds” for the senior persona scoring algorithm shown in FIG. 20. FIG. 14 shows a high-level flow diagram illustrating by way of example the steps performed to generate the trait qualifiers for the senior persona scoring algorithm depicted in FIG. 20. FIG. 15 shows examples of inputs and outputs to the trait qualifier generating algorithm of FIG. 14. In step 1405 of FIG. 14, the system receives from the community information dataset 1410 a list of common demographic attributes for the population of the selected community. As shown in FIG. 15, examples of common demographic attributes include attributes such as religion, financial status, race, gender and age, to name a few. Common demographic attributes exist when multiple residents in the current population of the senior living community share the same value for one or more of demographic attributes. In other words, if there are multiple residents in the community who are Christian (religion attribute), multiple residents who are Catholic (religion attribute), multiple residents who are Jewish (religion attribute), multiple residents who male (gender attribute), and multiple residents who are white (race attribute), then the list of common demographic attributes retrieved by the system in step 1405 will include the common demographic attributes of religion, gender and race.

At steps 1415, 1420 and 1425 of FIG. 14, the system selects one of the common demographic attributes on the list, retrieves the weights previously assigned by the community operator to certain values for the selected common demographic attribute, and determines the set of all possible values for the selected common demographic attribute. For example, if the system selects the common demographic attribute of gender, then the set of all possible values for this selected attribute is (male, female). In step 1430, one of the possible values is selected (e.g., the “male” value for the gender attribute) and the system determines, in steps 1435 and 1437 whether the selected possible value is one of the values previously assigned a weight. If the selected possible value has not been assigned a weight, then processing jumps to step 1450. But if the selected value has been assigned a weight, then the system determines the value density for the selected value by dividing the number of people in the selected community that have the selected value by the total number people in the community. For instance, if there are 100 residents in the community, 35 of whom are male, then the value density for the male value of the gender common demographic attribute is 35%, and the value density for the female value of the gender common demographic attribute is 65%.

The trait qualifier for the selected value of the selected common demographic attribute is generated in step 1445 by applying the weight assigned to the selected value of the selected common demographic attribute based on the value density of the selected value. For instance, the community operator may have decided that if the value density of male residents in the current population is less than 40%, then the weight that should be used as the trait qualifier in the persona scoring for male candidates is 10, thereby ensuring that that the persona scoring algorithm of FIG. 20 will add 10 points to the total persona score of male candidates. Thus, male candidates are more likely to get higher persona scores than female candidates, if all other factors are equal. However, the community operator may have also decided that if the value density of male residents in the current population is equal to or greater than 75%, then the weight that should be used as the trait qualifier in the persona scoring for male candidates is negative 10, thereby ensuring that the persona scoring algorithm of FIG. 20 will subtract 10 points from the total persona score of male candidates. This will result in male candidates getting lower total persona scores than female candidates, all other factors being equal.

The exact formula used by the community operator to determine the weights for any particular value for any particular common demographic attribute is not a critical aspect of the invention. A variety of formulas, rules or multipliers could be developed and used interchangeably, depending on the circumstances and the resident recruiting demographics of the community operator. Typically, the weights (or weighting rules) chosen by the community operator will be selected to drive up the persona scores of candidates having certain coveted trait values for a common demographic attribute, while driving down the persona scores of candidates who do not have those coveted trait values. Thus, the weights (or weighting rules) are a tool provided by embodiments of the present invention that a community operator may use to pursue a goal of balancing and/or diversifying the current population of the community, or identifying, attracting and persuading more candidates who have traits like the current population to move into the community. Additional examples of weights and weighting rules that could be used by embodiments of the present invention to generate the trait qualifiers that are designed to achieve certain effects are shown in FIG. 16.

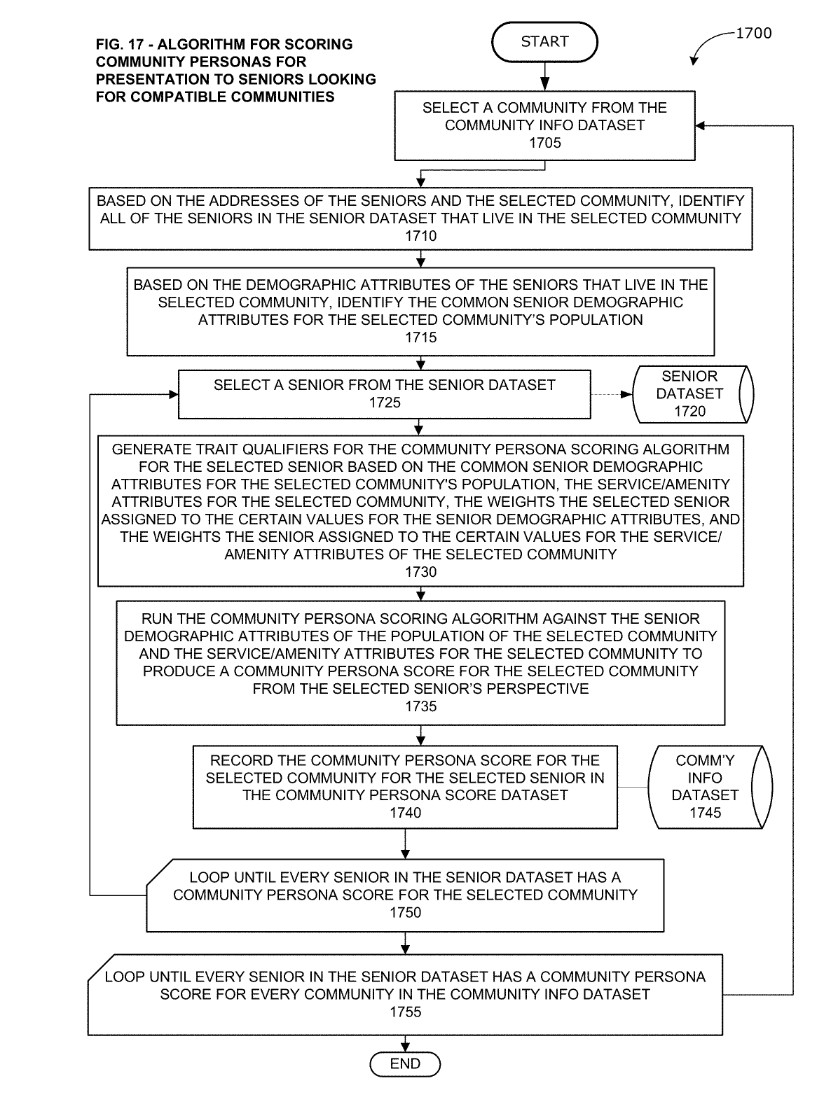

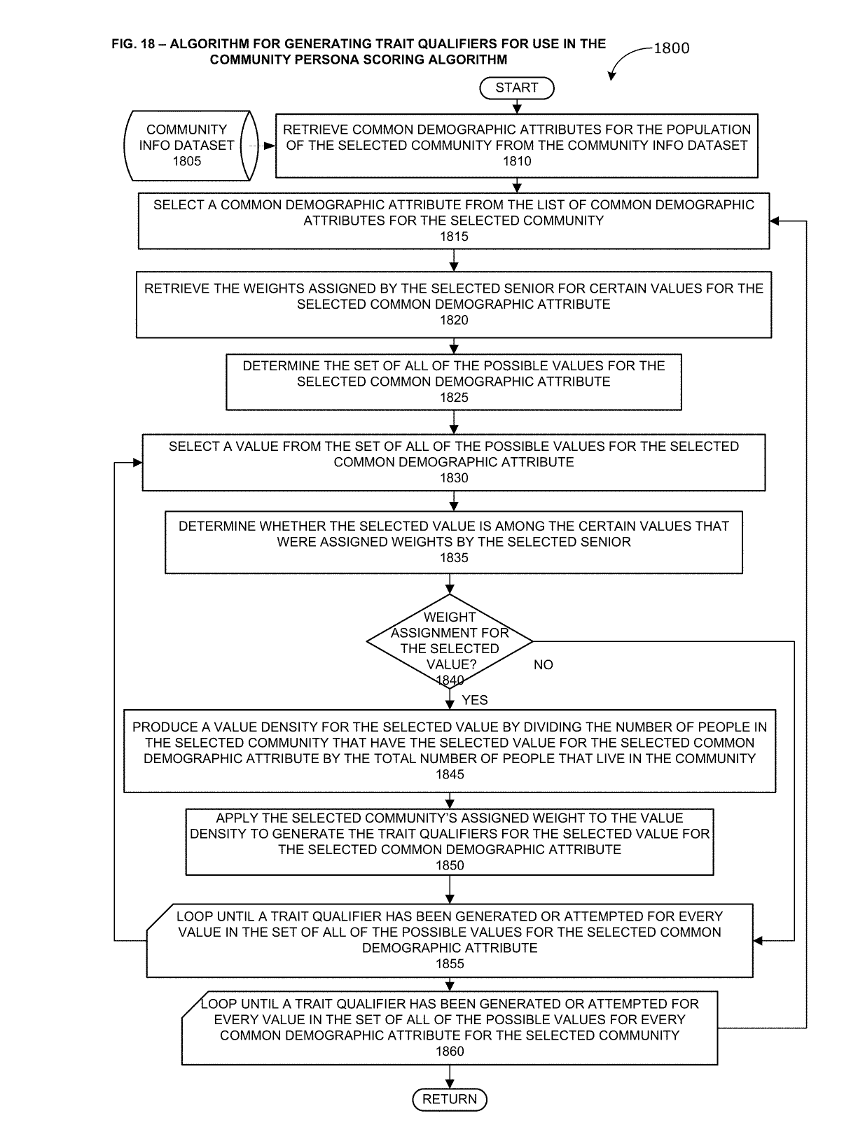

In the previously discussed algorithms, the system matched and scored senior personas for senior living communities. In another mode of operation, the system may be used by seniors to match and score senior living community personas. FIG. 17 shows a high-level flow diagram 1700 illustrating by way of example the steps performed in an algorithm for scoring community personas for presentation to seniors looking for compatible senior living communities. As shown in steps 1705 and 1710 of FIG. 17, the system first selects a community, and then identifies seniors that live in that community based on the addresses of the seniors in the senior dataset and the address of the selected community. At step 1715, the system determines the common demographic attributes for the selected community's population based on the demographic attributes of the seniors that live in the selected community. In step 1725, the system selects a senior from the senior dataset. Next, in step 1730, the system generates trait qualifiers for the community persona scoring algorithm for the selected senior. The selection of the trait qualifiers is based on the common senior demographic attributes for the selected community's population, the service/amenity attributes for the selected community, the weights the selected senior assigned to the certain values for the common demographic attributes, and the weights the senior assigned to the certain values for the service/amenity attributes of the selected community. FIG. 18 shows a high-level flow diagram illustrating by way of example the steps performed in an algorithm for generating trait qualifiers for use in the community persona scoring algorithm. The logic of the algorithm illustrated by the flow diagram of FIG. 18 is substantially the same as the logic of the algorithm illustrated by the flow diagram of FIG. 14, except that the weights are previously assigned to certain values for the common demographic attribute traits by the senior, not the senior living community.

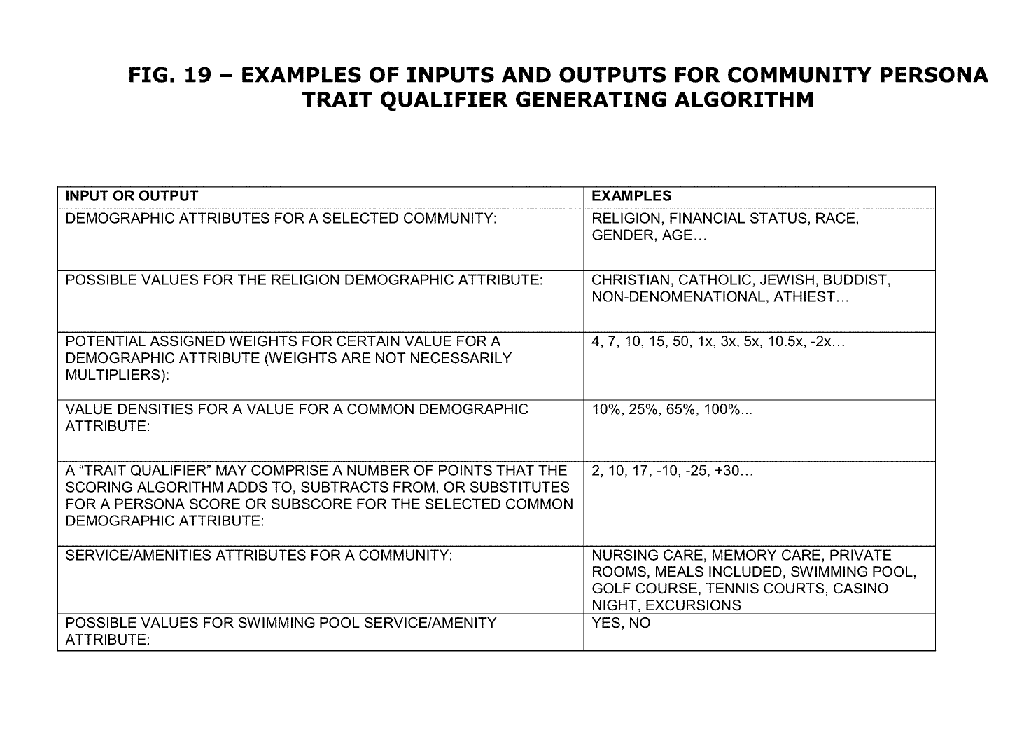

The trait qualifier for the selected value of the selected common demographic attribute is generated in step 1730 by applying the weight assigned to the selected value of the selected common demographic attribute based on the value density of the selected value. For instance, a male senior may have decided that if the value density of male residents in the current population of the senior living community is greater than 50%, then the weight that should be used as the trait qualifier in the community persona scoring algorithm for senior living community candidates is negative 10, thereby ensuring that that the community persona scoring algorithm will subtract 10 points from the community persona score of any senior living community that is more than 50% male. Thus, senior living community candidates with male populations greater than 50% are more likely to get lower persona scores than senior living community candidates with more female residents than male residents, if all other factors are equal. FIG. 19 shows examples of inputs and outputs for the community persona trait qualifier generating algorithm illustrated by the flow diagram of FIG. 18.

After the trait qualifiers have been generated, those trait qualifiers are plugged into a community persona scoring algorithm (not shown in the figures), which is run against the senior demographic attributes of the population of the selected community and the service/amenity attributes for the selected community to produce a community persona score for the selected community from the selected senior's perspective. However, the logic for the community persona scoring algorithm is substantially the same as the logic for the senior persona scoring algorithm, which is illustrated in FIG. 20 and discussed immediately below.

FIG. 20 shows a high-level flow diagram 2000 illustrating by way of example the steps performed in an algorithm for scoring senior personas according to one implementation of the invention. Typically, this algorithm will be called from step 1235 of FIG. 12, wherein the trait qualifiers have already been generated and a particular senior has already been selected for scoring. In order to calculate the score for the selected senior, the system first calculates the demographic qualifier scores (A₁, A₂, A₃, . . . , Aₙ) for the selected senior by comparing the selected senior's values for certain demographic attributes (e.g., location, care type, gender, religion, etc.) to the values provided by the senior living community operator (see step 2005) for those demographic attributes. For example, the senior living community may decide and specify that the value of “Chicago” for the location demographic attribute deserves 5 extra points, the value of “male” for the gender demographic attribute is entitled to 10 extra points, and the value of “Jewish” for the region demographic attribute is worth an additional 15 extra points. Accordingly, the system is configured to receive from the community the community-specified weights of 5, 10 and 15 for the values of Chicago, male and Jewish, respectively, for the demographic attributes of location, gender and religion. If the selected senior is a man living in Chicago who is Catholic, then his sub score for A₁ is 5, his sub score for A₂ is 10 and his sub score for A₃ is zero. So the selected senior will get a total of 15 points for his demographic score because he meets the qualifications of demographic qualifiers A₁ and A₂ (because he has the same values for these attributes as the values specified and weighted by the community), but does not meet the qualification for demographic qualifier A₃ because his value for the religion demographic attribute is “Catholic,” which is not equal to the community-specified value of “Jewish” for the religion demographic attribute. Note that it is possible that a different senior, who has a different set of values for the community demographic attributes that are specified and weighted by the community, will get more or fewer points for the demographic qualifiers (A₁, A₂, A₃, . . . , Aₙ).

In some situations, a community wishes to assign weights to certain values for certain common demographic attributes (traits) based on the value densities for those traits in the community's current population. These are called trait qualifiers. For example, if the current value density for male residents in the community is below 40%, then the community may provide the system with a weighting rule that automatically allocates more weight (and therefore more senior persona points) to male candidates than female candidates. By using the specified weighting rule to calculate the trait qualifier portion of the senior persona scores, a slight preference will be given to male candidates until the value density of males in the community again reaches 40%. At step 2010, the system calculates the trait qualifier scores (B₁, B₂, B₃ . . . Bₙ) for the selected senior by comparing the selected senior's traits to the generated trait qualifiers for each common demographic attribute for the senior living community. For example, if the trait qualifier weights for the senior living community are 100, 200 and 300 for the values of “Jewish” (religion common demographic attribute), “female” (gender common demographic attribute) and “veteran” (military status common demographic attribute), then senior candidates who are female, Jewish and veterans will have an additional 600 points added to the trait qualifier component of their overall senior persona scores.

Certain events that are associated with a senior may be considered by the senior living community as worthy of additional points for that senior's senior persona score. For example, the community may decide that certain affirmative actions performed by a senior, such as taking a tour or filling out a form on the community's website, deserves additional points added to that senior's persona score so that that senior will have a higher score and therefore get some additional attention. A senior living community could also decide that certain passive events associated with a particular senior, such as having a spouse who recently passed away, or being related to someone who already lives in the community, are worthy of additional points for the senior persona score. These additional qualifications are called event qualifiers. The senior living community can specify, for example, that if the value for the “tour taken” attribute is “yes” for a senior candidate, then that senior candidate gets an extra 20 points added to the event qualifier component of his or her total senior persona score. At step 2015, the system calculates the event qualifier scores (C₁C₂, C₃ . . . Cₙ) for the selected senior by comparing the values associated with the senior for certain values provided by the senior living community for certain attributes that are subjectively more (or less) important to the community. For example, if the community specifies that the values of “yes,” “yes” and “yes” for the attributes of “tour taken,” “form completed” and “responded to a direct mail flyer” are to be weighted as 50, 25 and 10, respectively, and the values for a particular candidate for these attributes are “no,” “yes” and “no,” then, for that particular candidate, the event qualifiers are C₁=0, because no tour was taken, C₂=25 because a form was completed, and C₃=0 because the candidate did not respond to the direct mail flyer. Therefore, the senior candidate will have 25 points added to the qualifier component of his or her total persona score because (C₁, +C₂, +C₃=25).

As shown in steps 2020, 2025 and 2030 of FIG. 20, the system calculates the total objective qualifier score A by summing together all the demographic qualifiers (A=A₁, +A₂,+A₃, . . . , +Aₙ), calculates the total trait qualifier score B by summing together all the trait qualifiers (B=B₁+B₂, +B₃ . . . +Bₙ), and calculates the total event qualifier score C by summing together all the event qualifiers (C=C₁,+C₂,+C₃ . . . +Cₙ). And finally, in step 2035, the system calculates the total senior persona score for the selected senior by summing together the total demographic qualifier score A, the total trait qualifier score B, and the total event qualifier score C (TOTAL SENIOR PERSONA SCORE=A+B +C).

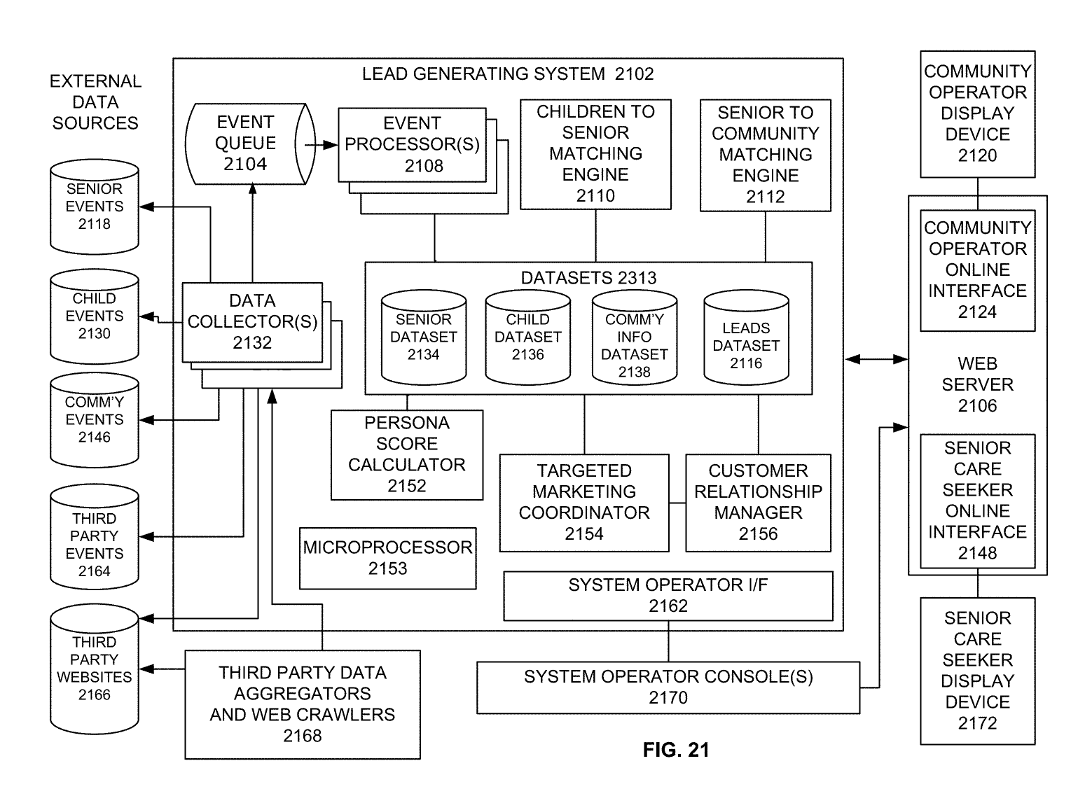

FIG. 21 shows a high-level block diagram of a lead generating system 2102 configured to operate according to one implementation of the invention. As shown in FIG. 21, the lead generating system 2102 typically comprises a microprocessor 2153 and a collection of computer programs (or programming modules) containing programming instructions that, when executed by the microprocessor 2153, will cause the microprocessor 2153 to carry out certain functions as herein described. In this case, the collection of computer programs includes an event queue 2104, an event processor 2108, a children to senor matching engine 2110, a senior to community matching engine 2112, a data collector 2132 and a persona score calculator 2152.

The data collector 2132 continuously scans, monitors and mines data from a plurality of different external data sources, including a senior events dataset 2118, a child events dataset 2130, a community events dataset 2146, a dataset of third party events 2164 and third party websites 2166. The external data sources provide the system with access to information about senior living communities, seniors, children of seniors and events related to seniors and senior living communities. The types of data accessed may comprise, for example, census data, real property sales listings, county property registrations, the National Change of Address dataset, direct mail suppression lists (for deceased persons), automobile sales records, motor vehicle department records, obituaries (containing names of widows and widowers), registrations data for websites containing content of special interest to seniors, records associated with buying, selling and registering wheelchairs and walkers, ambulatory records, etc.

The data collector 2132 may be configured to monitor, retrieve and process data from any combination of the external data sources via a variety of different technical mechanisms, including without limitation, using third party data aggregators and web crawlers 2168. The data obtained from these external sources also may be supplemented with additional data separately obtained from other sources (not shown in FIG. 21) and manually input to the online scoring and matching system 2102 using a system operator console 2170 connected to the lead generating system 2102 via a system operator interface 2162.

The event queue 2104 organizes the data collected by the data collector 2132 and sends it to the event processor 2108, which filters out irrelevant information, cross-references and tags the relevant information, and then stores the tagged and filtered information in a collection of datasets 2313 for subsequent access and use by other modules on the system. To this end, the collection of datasets 2313 comprise a senior dataset 2134 for storing information about seniors in a target population, including their names, addresses and attributes, a child dataset 2136, which stores information about the children of seniors, including information about their parents, as well as information about any activities of the children that may be considered an early indicator of senior care need for a parent. The collection of datasets 2313 also include a community information dataset 2138 containing information about senior living communities in a target area, including their addresses, population demographics, demographic qualifiers, event qualifiers and trait qualifiers. The collection of datasets 2313 may also include a leads dataset 2116, where information about potential matches and matched candidates are stored after identification by various matching engines and scoring modules on the system. Although not shown in FIG. 21, the collection of datasets 2313 may further include a staffing dataset, which contains staffer attributes, including names, addresses, certifications, work histories, training and experience data, etc., associated with potential staff workers for senior living communities. Preferably, the data collector 2132, the event queue 2104 and the event processor 2108 cooperate to continuously collect, process, filter, refine and grow the senior and senior community information stored in the collection of datasets 2313, without being affected by the activities and the current states of the children to senior matching engine 2110, the senior to community matching engine 2112 or the persona score calculator 2152, which are described in more detail below.

The child to senior matching engine 2110 constantly retrieves and cross-references senior data stored in the senior dataset 2134 and child data stored in the child dataset 2136 in order to identify and record (in both datasets) parent-child relationships among seniors and children in a target population based on common names, common addresses, common events, common family members, common responses to survey questions, etc. The senior to community matching engine 2112 carries out the many-to-one and many-to-many matching algorithms, described above in connection with the discussions of FIGS. 9-20, to find matches between seniors and senior living communities based on the senior attributes and senior living community attributes stored in the senior dataset and community information dataset 2138, respectively. The senior to community matching engine 2112 may also be suitably configured to carry out the trait qualifier generating functions described above in connection with the flow diagrams of FIGS. 14 and 18.

The persona score calculator 2152 calculates the senior persona scores for senior candidates, as well as community persona scores for senior living communities, in accordance with the steps of the flow diagram depicted in FIG. 20. The persona score calculator may also be configured to calculate scores for staff member candidates using the same or similar logic as the logic described in respect to FIG. 20, except that the data used for calculating staff persona scores uses staff attributes instead of senior attributes.

The lead generating system 2102 is typically accessed by a community operator logged onto a community operator display device 2120, such as a personal computer system, tablet computer or smartphone, and a community operator online interface 2124 running on a web server 2106. The web server 106 is communicatively coupled to the lead generating system 2102 to provide access to users over the Internet (not shown). Similarly, the lead generating system 2102 may be accessed by a senior logged onto a senior care seeker display device 2172, such as a personal computer, tablet computer or smartphone, and an online interface 2148 running on the web server 2106.

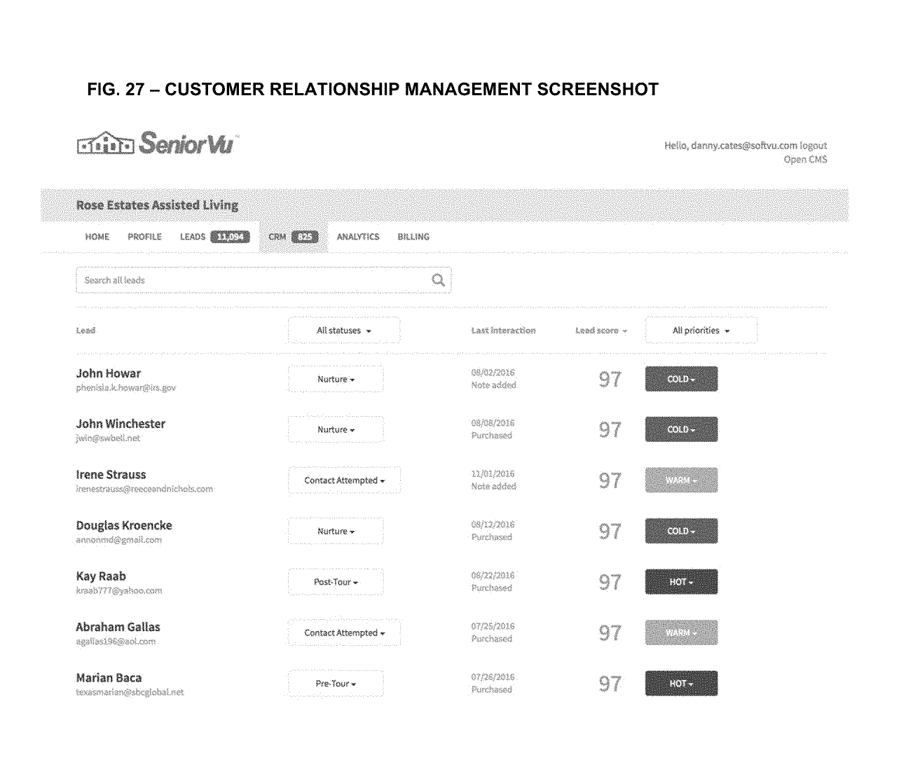

The lead generating system 2102 may optionally include a targeted marketing coordinator 2154 and a customer relationship manager 2156, both of which can be automatically invoked on behalf of senior living community operators to initiate and manage automated targeted marketing campaigns adapted to convince matched and scored seniors and staffers to consider moving into or applying for employment at the senior living community. FIG. 27 shows an exemplary screenshot of the output from the customer relationship manager 2156.

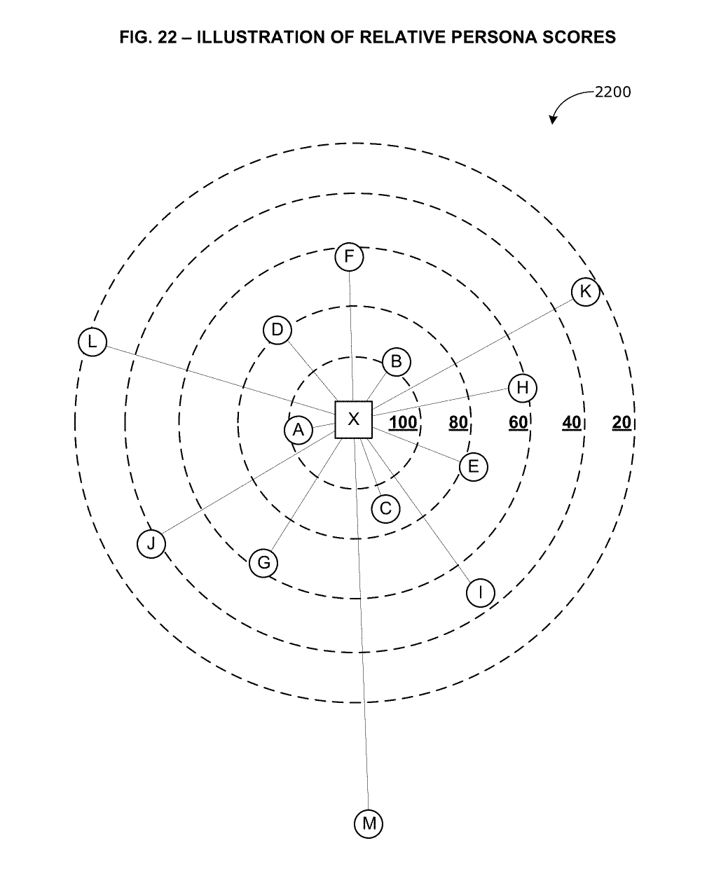

FIG. 22 shows a diagram illustrating the relative senior persona scores of a collection of seniors A-M as viewed from the perspective of a senior living community X according to one implementation of the invention. In this diagram, the box marked X in the center of the diagram represents the senior living community X, and the circles marked A through M are placed on the chart so that their relative distances from the community X reflects the magnitude of the senior persona scores for seniors A through M, as viewed from the perspective of community X. Thus, a senior with a higher senior persona score is closer to the community X on the chart than a senior with a lower senior persona score. As shown in the example of FIG. 22, senior A's senior persona score is better than 100. Therefore, senior A is shown in very close proximity to community X. Senior K, on the other hand, has a score of just above 20, and is therefore shown on the diagram as being relatively far away from the community X, consistent with the lower senior persona score of senior K. The relative positions of seniors A and K on the senior persona score chart of FIG. 22 indicates that senior A is a very good fit for community X, and senior K, relative to senior A, is not as good a fit as senior A.

FIG. 22 may also illustrate the relative community persona scores of communities A through M, as viewed from the perspective of senior X using the lead generating system to find a compatible senior living community. Viewed this way, it can be seen that community A has a much higher community persona score than community K (as viewed from the perspective of senior X), and therefore senior X should consider community A to be a better fit for senior X than community K.

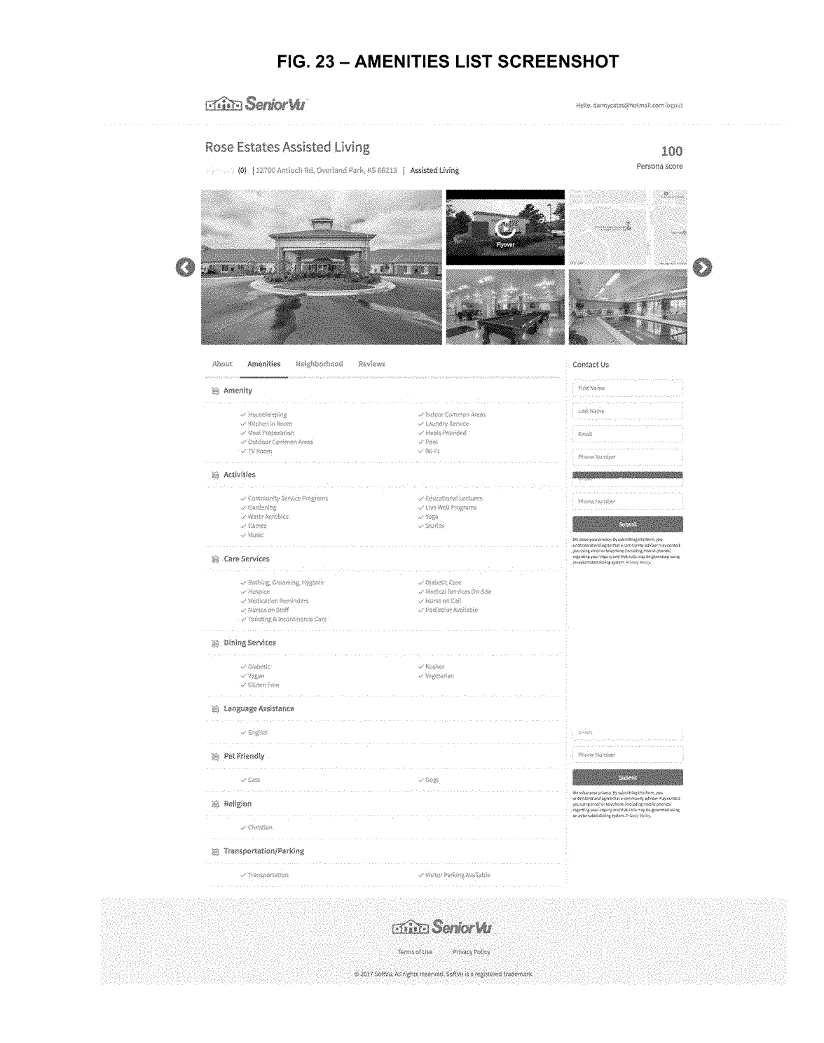

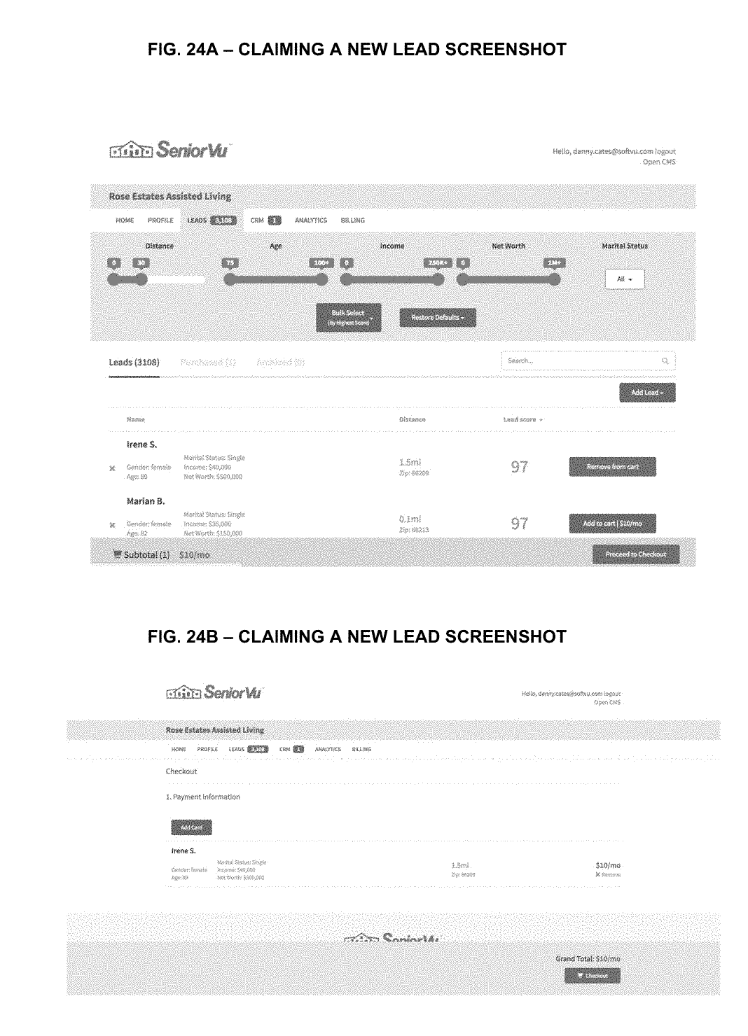

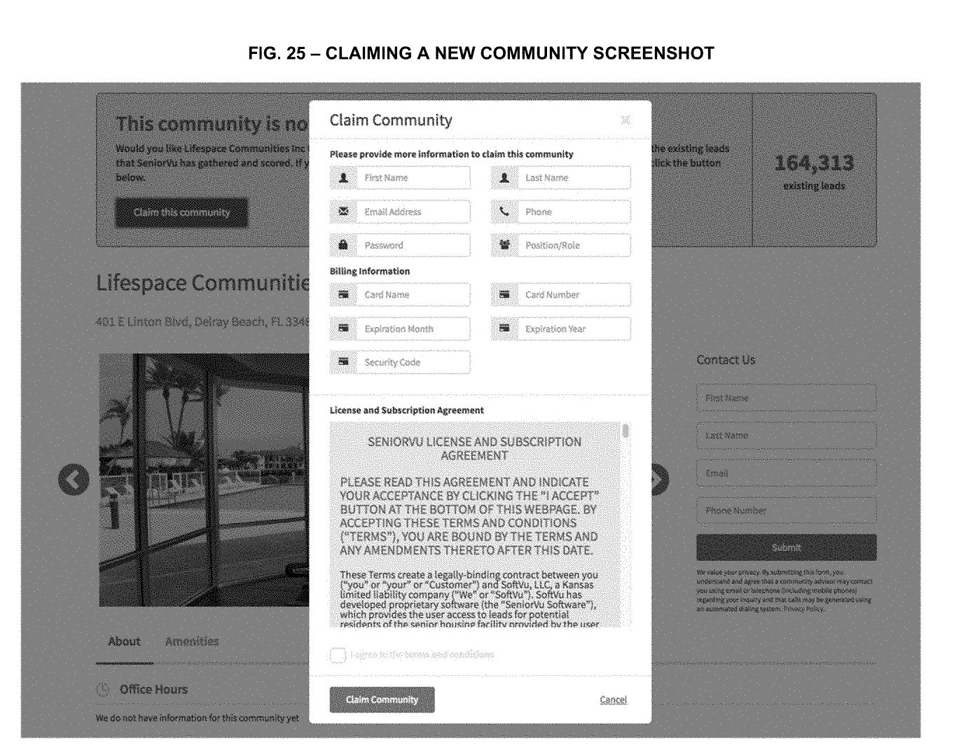

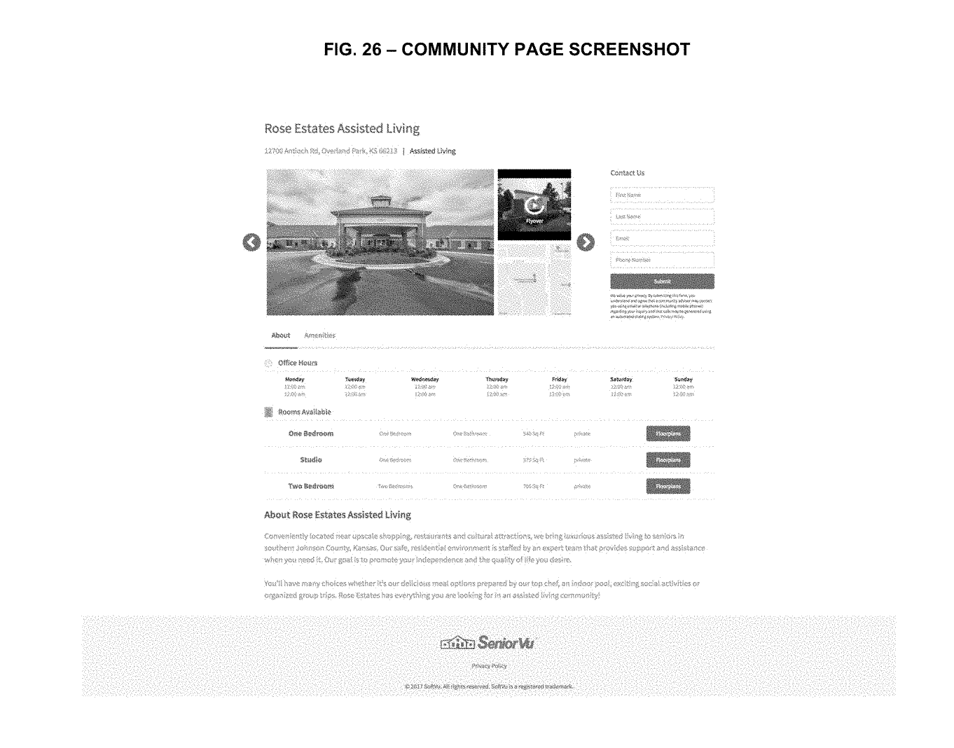

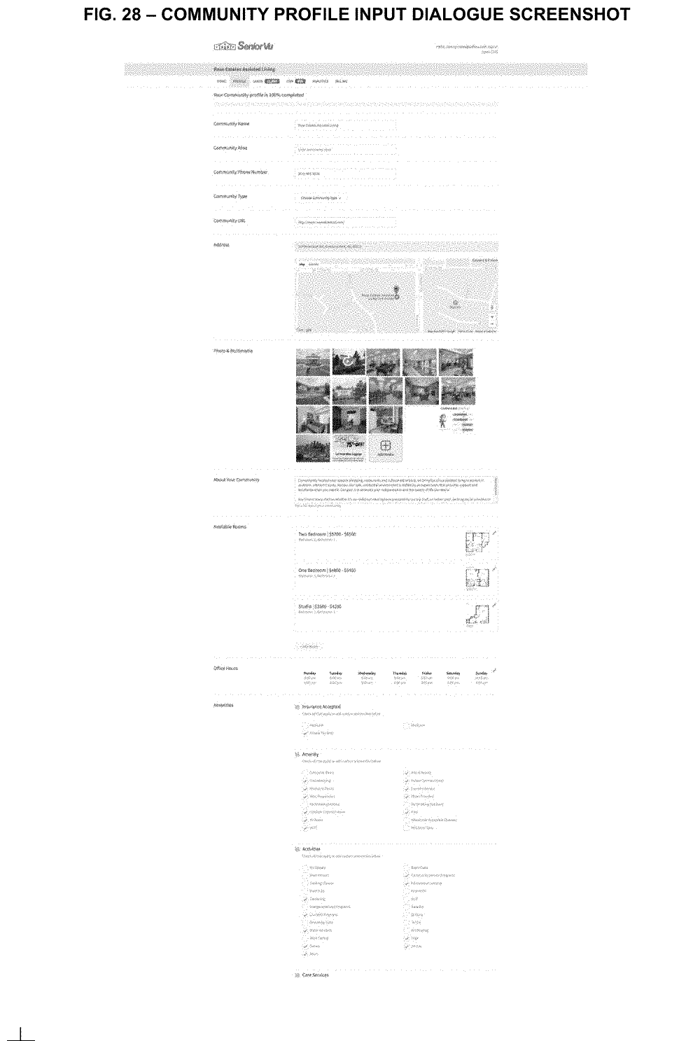

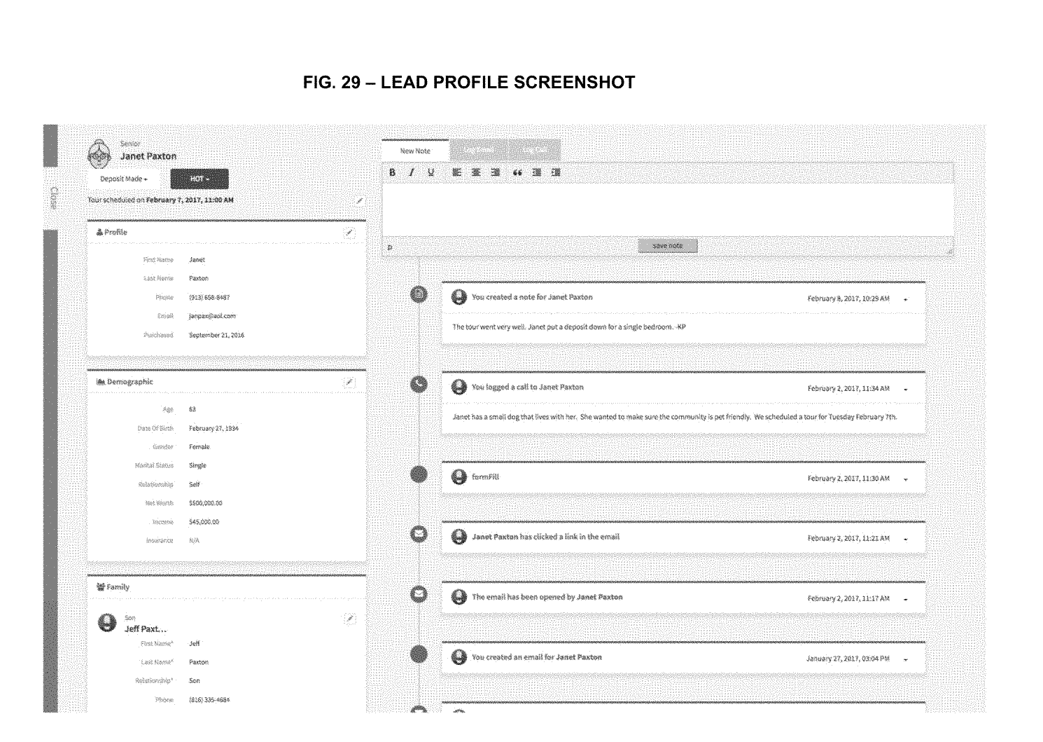

FIGS. 23 through 30 contain exemplary screenshots from a web interface to the computer network of one embodiment of the present invention. FIG. 23 shows an exemplar screenshot of a webpage that could be displayed on the community operator's display device or the senior care seeker display device to permit the community operator and/or the senior care seeker to review the amenities of a senior living community.

The flow and block diagrams and screenshots described considerable detail above illustrate embodiments of the invention that permit senior living communities to identify and score potential customers and seniors to identify and score potential communities. However, it will be understood by those skilled in the art upon reading this disclosure that the present invention may be configured to permit senior living communities to identify and score potential employees (staff members), instead of potential customers. This is accomplished essentially by replacing the senior dataset, the senior demographic attributes, the senior-specified demographic, trait and event qualifiers, and the assigned weights, with staffer related data, such as a staffer dataset, a set of staffer demographic attributes, a set of staffer-specified demographic, trait and event qualifiers, and staffer-related weights. It will be further understood by those skilled in the art that the system may also be reconfigured to permit senior care seekers and job applicants (staffers) to use the systems and processes herein described to identify, score and display compatible senior living communities based on senior care types, community demographic attributes, qualifiers and weights provided by the senior care seekers and staffer job applicants.

Thus, in another implementation of the present invention, there is provided a method for identifying potential communities for a senior care seeker using a lead generating system, comprising the steps of: a) creating a leads dataset on the lead generating system; b) creating a senior care seeker dataset on the lead generating system, the senior care seeker dataset comprising a senior care type and senior care seeker demographic attributes for the senior care seeker; c) creating a community dataset on the lead generating system by monitoring a community data source to identify and store a plurality of senior living communities in the target area, community demographic attributes associated with the plurality of senior living communities in the target area, and community events associated with the plurality of senior living communities in the target area; d) on the lead generating system, comparing the senior care seeker demographic attributes to the community demographic attributes for the plurality of senior living communities in the community dataset to establish a match between the senior care seeker, the senor care type and a potential community; e) creating a potential community record in the leads dataset, the potential community record comprising the community demographic attributes for the potential community and the senior care type; f) establishing a data communications link to a display device controlled by the senior care seeker; and g) transmitting at least a portion of the potential community record in the leads dataset from the lead generating system to the display device controlled by the senior care seeker via the data communications link.

In preferred embodiments of this implementation, community persona scores are calculated for the communities to help the senior care seekers and job applicants sort and rank the matched communities by compatibility. Accordingly, systems and processes configured in accordance with this implementation of the invention may further include the steps of: a) calculating a community persona score for the potential community, the community persona score including a demographic qualifier score; b) receiving from the senior care seeker, via the data communications link, a demographic qualifier for a community demographic attribute, the demographic qualifier comprising a senior care seeker-specified value for the community demographic attribute; c) receiving a demographic qualifier weight assigned to said senior care seeker-specified value for said community demographic attribute; d) comparing said senior care seeker-specified value for said community demographic attribute to a community value associated with the potential community for said community demographic attribute; e) adding the demographic qualifier weight to the demographic qualifier score of the senior persona score if the customer value for said community demographic attribute is equal to the community-specified value for the community demographic attribute; and f) transmitting the community persona score for the potential community to the computer system controlled by the senior care seeker via the data communications link. Similar steps may be carried out to determine the trait qualifier score component and/or the event qualifier score component of the community's overall community person score. With minor adjustments to account for job applicant data, instead of senior care seeker data, these steps can also be used to permit searching, matching and scoring of communities by job applicants, instead of senior care seekers.

The present invention also provides a lead generating system for identifying potential communities for a senior care seeker. In this implementation, the lead generating system comprises: a) a leads dataset; b) a senior care seeker dataset that stores a senior care type and senior care seeker demographic attributes for the senior care seeker; c) a data collector monitors a community data source to identify and store a plurality of senior living communities in the target area, community demographic attributes associated with the plurality of senior living communities in the target area, and community events associated with the plurality of senior living communities in the target area; d) a senior to community matching engine that (i) compares the senior care seeker demographic attributes to the community demographic attributes for the plurality of senior living communities in the community dataset to establish a match between the senior care seeker, the senor care type and a potential community, and (iii) creates a potential community record in the leads dataset, the potential community record comprising the community demographic attributes for the potential community and the senior care type; e) a data communications link to a display device controlled by the senior care seeker; and f) a web server that transmits at least a portion of the potential community record in the leads dataset from the lead generating system to the display device controlled by the senior care seeker via the data communications link.

The lead generating system for identifying potential communities may also be configured to calculate community persona scores. Thus, the lead generation system may further include a persona calculator that: a) calculates a community persona score for the potential community, the community persona score including a demographic qualifier score; b) receives from the senior care seeker, via the data communications link, a demographic qualifier for a community demographic attribute, the demographic qualifier comprising a senior care seeker-specified value for the community demographic attribute; c) receives a demographic qualifier weight assigned to said senior care seeker-specified value for said community demographic attribute; d) compares said senior care seeker-specified value for said community demographic attribute to a community value associated with the potential community for said community demographic attribute; e) adds the demographic qualifier weight to the demographic qualifier score of the senior persona score if the customer value for said community demographic attribute is equal to the community-specified value for the community demographic attribute; and f) transmits the community persona score for the potential community to the computer system controlled by the senior care seeker via the data communications link. With minor adjustments to account for job applicant data, instead of senior care seeker data, these components can also be used to permit searching, matching and scoring of communities by job applicants, instead of senior care seekers.

Although the exemplary embodiments, uses and advantages of the invention have been disclosed above with a certain degree of particularity, it will be apparent to those skilled in the art upon consideration of this specification and practice of the invention as disclosed herein that alterations and modifications can be made without departing from the spirit or the scope of the invention, which are intended to be limited only by the following claims and equivalents thereof.

What is claimed is:

1. A process for identifying potential customers for senior living communities using a lead generation system, the process comprising:
a) creating a leads dataset on the lead generating system;
b) creating a community dataset on the lead generating system by monitoring a community data source to identify and store a senior care type, a plurality of senior living communities that provide said senior care type, and community demographic attributes associated with the plurality of senior living communities;
c) monitoring an early indicator data source to detect an early indicator for the senior care type, a potential customer for the senior care type, and customer demographic attributes for the potential customer;
d) on the lead generating system, comparing the customer demographic attributes to the community demographic attributes for a senior living community in the community dataset to establish a match between the potential customer and the senior living community;
e) creating a potential customer record in the leads dataset, the potential customer record comprising the customer demographic attributes for the potential customer and the senior care type;
f) establishing a data communications link to a display device controlled by the senior living community; and
g) transmitting at least a portion of the potential customer record in the leads dataset from the lead generating system to the display device controlled by the senior living community via the data communications link.

2. The process of claim 1, wherein the early indicator is detected based on an action of the potential customer.

3. The process of claim 1, further comprising:
a) creating a senior dataset on the lead generating system by monitoring a demographic data source to identify and store seniors in a target population, senior demographic attributes associated with said seniors in the target population, and senior events associated with said seniors in the target population;
b) on the lead generating system, comparing the customer demographic attributes for the potential customer to the senior demographic attributes for a senior in the senior dataset to establish a second match between the potential customer and the senior in the senior dataset;
c) adding the customer demographic attributes to the senior demographic attributes in the senior dataset; and
d) adding the second match and the senior demographic attributes for the matched senior in the senior dataset to the potential customer record in the leads dataset.

4. The process of claim 3, further comprising:
a) calculating a senior persona score for the potential customer, the senior persona score including a demographic qualifier score;
b) receiving from the senior living community, via the data communications link, a demographic qualifier, the demographic qualifier comprising a community-specified value for a senior demographic attribute;
c) receiving a demographic qualifier weight assigned to said community-specified value for said senior demographic attribute;
d) comparing said community-specified value for said community demographic attribute to a customer value associated with the potential customer for said senior demographic attribute;
e) adding the demographic qualifier weight to the demographic qualifier score of the senior persona score if the customer value for said senior demographic attribute is equal to the community-specified value for the senior demographic attribute; and
f) transmitting the senior persona score for the potential customer to the display device controlled by the senior living community via the data communications link.

5. The process of claim 1, further comprising:
a) calculating a senior persona score for the potential customer, the senior persona score including a trait qualifier score;
b) receiving from the senior living community, via the data communications link, a trait qualifier for a common demographic attribute of the senior living community, the trait qualifier comprising a community-specified value for the common demographic attribute;
c) receiving a trait qualifier weight assigned to said community-specified value for said common demographic attribute;
d) comparing said community-specified value for said common demographic attribute to a customer value associated with the potential customer for said common demographic attribute; and
e) adding the trait qualifier weight to the trait qualifier score of the senior persona score if the customer value for said common demographic attribute is equal to the community-specified value for the common demographic attribute; and
f) transmitting the senior persona score for the potential customer to the display device controlled by the senior living community via the data communications link.

6. The process of claim 5, further comprising:
a) calculating a value density for the community-specified value for the common demographic attribute;
b) receiving on the lead generating system a rule for modifying the trait qualifier based on the value density calculation; and
c) modifying the trait qualifier in accordance with the rule.

7. The process of claim 6, further comprising receiving the rule from the senior living community via the data communications link.

8. The process of claim 3, further comprising:
a) calculating a senior persona score for the potential customer, the senior persona score including an event qualifier score;
b) receiving from the senior living community, via the data communications link, an event qualifier for a senior event, the senior event qualifier comprising a community-specified value for the senior event;
c) receiving an event qualifier weight assigned to said community-specified value for said senior event;
d) comparing said community-specified value for said community demographic attribute to a customer value associated with the potential customer for said senior event; and
e) adding the event qualifier weight to the event qualifier score of the senior persona score if the customer value for said senior event is equal to the community-specified value for the senior event; and
f) transmitting the senior persona score for the potential customer to the display device controlled by the senior living community via the data communications link.

9. The process of claim 3, further comprising:
a) calculating a senior persona score for the potential customer, the senior persona score comprising the sum of a demographic qualifier score, a trait qualifier score and an event qualifier score;
b) receiving from the senior living community, via the data communications link, a demographic qualifier for a senior demographic attribute, the demographic qualifier comprising a community-specified value for the senior demographic attribute and a demographic qualifier weight assigned to said community-specified value for said senior demographic attribute;
c) receiving from the senior living community, via the data communications link, a trait qualifier for a common demographic attribute of the senior living community, the trait qualifier comprising a community-specified value for the common demographic attribute;
d) receiving a trait qualifier weight assigned to said community-specified value for said common demographic attribute;
e) receiving from the senior living community, via the data communications link, an event qualifier for a senior event, the event qualifier comprising a community-specified value for the senior event;
f) receiving an event qualifier weight assigned to said community-specified value for said senior event;
g) comparing said community-specified value for said first community demographic attribute to a customer value associated with the potential customer for said first community demographic attribute;
h) adding the demographic qualifier weight to the demographic qualifier score of the senior persona score if the customer value for said senior demographic attribute is equal to the community-specified value for the senior demographic attribute.
i) comparing said community-specified value for said common demographic attribute to a customer value associated with the potential customer for said common demographic attribute; and
j) adding the trait qualifier weight to the trait qualifier score of senior persona score if the customer value for said common demographic attribute is equal to the community-specified value for the common demographic attribute;
k) comparing said community-specified value for said senior event to a customer value associated with the potential customer for said senior event;
l) adding the event qualifier weight to the event qualifier score of the senior persona score if the customer value for said senior event is equal to the community-specified value for the senior event; and
m) transmitting the senior persona score for the potential customer to the display device controlled by the senior living community via the data communications link.

10. The process of claim 9, further comprising:
a) creating a second potential customer record in the leads dataset, the second potential customer record comprising the customer demographic attributes for a second potential customer and the senior care type;
b) calculating a second senior persona score for the second potential customer by summing together a demographic qualifier score for the second potential customer, a trait qualifier score for the second potential customer and an event qualifier score for the second potential customer;
c) rank ordering the potential customer and the second potential customer in accordance with the senior persona score and the second senior persona score; and
d) displaying the potential customer record and the second potential customer record on a display device accessible by the senior living community in accordance with the rank ordering.

11. The process of claim 3, further comprising:
a) creating a children dataset on the lead generating system by monitoring the demographic data source to identify and store children of the seniors in the target population and children demographic attributes associated with said children;
b) on the lead generating system, cross-referencing the senior demographic attributes and the children demographic attributes to identify a senior-child relationship match between the senior in the senior population dataset and a child in the children dataset; and
c) adding the senior-child relationship match to the potential customer record in the leads dataset.

12. The process of claim 11, wherein the early indicator is detected based on an action of the child.

13. A process for identifying potential customers for senior living communities using a lead generating system, the process comprising:
a) creating a leads dataset on the lead generating system;
b) creating a senior dataset on the lead generating system by monitoring a demographic data source to identify and store seniors in a target area and senior demographic attributes associated with the seniors in the target area;
c) creating a community dataset on the lead generating system by monitoring a community data source to identify and store a plurality of senior living communities in the target area and community demographic attributes associated with the plurality of senior living communities in the target area;
d) cross-referencing the senior demographic attributes with the community demographic attributes to determine which seniors in the target area residents of one of the plurality of senior living communities in the target area, which seniors in the target area are not residents of one of the plurality of senior living communities, the actual move-in dates for the residents of the plurality of senior living communities, and early indicators of senior care need associated with the residents of the plurality of senior living communities;
e) monitoring an early indicator data source to detect and store in the leads dataset an early indicator of senior care need by a non-resident senior in the target area, a senior care type for the non-resident senior, and customer demographic attributes for the non-resident senior;
f) on the lead generating system, comparing the early indicators of senior care need for the non-resident senior to the early indicators of senior care need for the resident seniors to generate an estimated future move-in date for the non-resident senior;
g) on the lead generating system, comparing the customer demographic attributes for the non-resident senior to the community demographic attributes for a senior living community to establish a match between a non-resident senior and the senior living community;
h) creating a potential customer record in the leads dataset for the non-resident senior, the potential customer record comprising the senior care type, the customer demographic attributes, and the estimated future move-in date for the non-resident senior;
i) establishing a data communications link to a display device controlled by the senior living community; and
j) transmitting at least a portion of the potential customer record in the leads dataset from the lead generating system to the display device controlled by the senior living community via the data communications link.

14. The process of claim 13, further comprising:
a) calculating a senior persona score for the non-resident senior, the senior persona score including a demographic qualifier score;
b) receiving from the senior living community, via the data communications link, a demographic qualifier for a senior demographic attribute, the demographic qualifier comprising a community-specified value for the senior demographic attribute;
c) receiving a demographic qualifier weight assigned to said community-specified value for said senior demographic attribute;
d) comparing said community-specified value for said senior demographic attribute to a customer value associated with the non-resident senior for said senior demographic attribute;
e) adding the demographic qualifier weight to the demographic qualifier score of the senior persona score if the customer value for said senior demographic attribute is equal to the community-specified value for the senior demographic attribute; and
f) transmitting the senior persona score for the non-resident senior to the display device controlled by the senior living community via the data communications link.

15. The process of claim 14, further comprising:
a) calculating a senior persona score for the non-resident senior, the senior persona score including a trait qualifier score;
b) receiving from the senior living community, via the data communications link, a trait qualifier for a common demographic attribute of the senior living community, the trait qualifier comprising a community-specified value for the common demographic attribute;
c) receiving a trait qualifier weight assigned to said community-specified value for said common demographic attribute;
d) comparing said community-specified value for said common demographic attribute to a customer value associated with the non-resident senior for said common demographic attribute; and
e) adding the trait qualifier weight to the trait qualifier score of senior persona score if the customer value for said common demographic attribute is equal to the community-specified value for the common demographic attribute; and
f) transmitting the senior persona score for the non-resident senior to the display device controlled by the senior living community via the data communications link.

16. The process of claim 15, further comprising:
a) calculating a value density for the community-specified value for the common demographic attribute;
b) storing on the lead generating system a rule for modifying the trait qualifier based on the value density calculation;
c) modifying the trait qualifier in accordance with the rule.

17. The process of claim 16, further comprising receiving the rule from the senior living community via the data communications link.

18. The process of claim 13, further comprising:
a) calculating a senior persona score for the non-resident senior, the senior persona score including an event qualifier score;
b) receiving from the senior living community, via the data communications link, an event qualifier, the event qualifier comprising a community-specified value for the senior event;
c) receiving an event qualifier weight assigned to said community-specified value for said senior event;
d) comparing said community-specified value for said event attribute to a customer value associated with the non-resident senior for said event attribute; and
e) adding the event qualifier weight to the event qualifier score of the senior persona score if the customer value for said event attribute is equal to the community-specified value for the event attribute; and
f) transmitting the senior persona score for the non-resident senior to the display device controlled by the senior living community via the data communications link.

19. A process for calculating senior persona scores for non-resident seniors for a senior living community using a computer system, the process comprising:
a) creating a senior dataset on the computer system, the senior dataset comprising senior demographic attributes, including names and addresses, for seniors in a target population;
b) creating a community dataset on the computer system, the community dataset comprising a community address, a set of common demographic attributes for the seniors who live in the senior living community, a set of operator-specified values for the set of common demographic attributes, and a set of weight rules associated with the set of operator-specified values, respectively;
c) generating a trait qualifier for every operator-specified value for every common demographic attribute in the set of common demographic attributes by calculating a value density for said every operator-specified value and applying the weight rule based on said value density;
d) cross-referencing the names and addresses of the seniors in the senior dataset with the community address in the community dataset to identify a non-resident senior for the senior living community;
e) using the senior demographic attributes from the senior dataset to determine the non-resident senior's value for every common demographic attribute in the set of common demographic attributes;
f) comparing the non-resident senior's value to the operator-specified value for each common demographic attribute in the set of common demographic attributes; and
g) adding the trait qualifier for the operator-specified value to the senior persona score for the non-resident senior if the non-resident senior's value for a common demographic attribute is equal to the operator-specified value for said common demographic attribute.

20. The process of claim 19, wherein calculating the value density for every operator-specified value for every common demographic attribute comprises:
a) selecting a common demographic attribute from the set of common demographic attributes;
b) determining the set of all possible values for the common demographic attribute;
and
c) for each possible value in the set of all possible values, dividing the number of seniors living in the senior living community who have said possible value for the common demographic attribute by the total number of seniors living in the senior living community.

21. The process of claim 19, wherein generating the trait qualifier comprises multiplying the value density by a specified weight.

22. The process of claim 19, wherein generating the trait qualifier comprises using a first number as the trait qualifier if the magnitude of the value density is greater than a specified percentage, and using a different number for the trait qualifier if the magnitude of the value density is less than or equal to the specified percentage.

23. The process of claim 19, further comprising:
a) creating a leads dataset on the computer system;
b) storing the senior persona score of the non-resident senior in the leads dataset;
a) establishing a data communications link to a display device controlled by the senior living community; and
b) transmitting the senior persona score for the non-resident senior to the display device via the data communications link.

24. A customer lead generating system for senior living communities, comprising:
a) a leads dataset;
b) a community dataset for storing a senior care type, a plurality of senior living communities that provide said senior care type, and community demographic attributes associated with the plurality of senior living communities;
c) a data collector that retrieves early indicator data from an early indicator data source;
d) an event processor that processes the early indicator data to detect an early indicator for the senior care type, a potential customer for the senior care type, and customer demographic attributes for the potential customer;
e) a senior to community matching engine that (i) compares the customer demographic attributes to the community demographic attributes for a senior living community in the community dataset to establish a match between the potential customer and the senior living community, and (ii) creates a potential customer record in the leads dataset, the potential customer record comprising the customer demographic attributes for the potential customer and the senior care type;
f) a data communications link to a computer system controlled by the senior living community; and
g) a web server that transmits at least a portion of the potential customer record in the leads dataset from the customer lead generating system to the computer system controlled by the senior living community via the data communications link.

25. The customer lead generating system of claim 24, wherein the event processor detects the early indicator based on an action of the potential customer.

26. The customer lead generating system of claim 24, further comprising:
a) a senior dataset for storing seniors in a target population and senior demographic attributes associated with said seniors in the target population; and
b) a children to senior matching engine that (i) compares the customer demographic attributes for the potential customer to the senior demographic attributes for a senior in the senior dataset to establish a second match between the potential customer and the senior in the senior dataset, (ii) adds the customer demographic attributes to the senior demographic attributes in the senior dataset, and (iii) adds the second match and the senior demographic attributes for the matched senior in the senior dataset to the potential customer record in the leads dataset.

27. The customer lead generating system of claim 26, further comprising a persona score calculator that:
a) calculates a senior persona score for the potential customer, the senior persona score including a demographic qualifier score;
b) receives from the senior living community, via the data communications link, a demographic qualifier for a senior demographic attribute, the demographic qualifier comprising a community-specified value for the senior demographic attribute;
c) receives a demographic qualifier weight assigned to said community-specified value for said senior demographic attribute;
d) compares said community-specified value for said senior demographic attribute to a customer value associated with the potential customer for said senior demographic attribute;
e) adds the demographic qualifier weight to the demographic qualifier score of the senior persona score if the customer value for said senior demographic attribute is equal to the community-specified value for the senior demographic attribute; and
f) transmits the senior persona score for the potential customer to the computer controlled by the senior living community via the data communications link.

28. The customer lead generating system of claim 24, further comprising a persona score calculator that:
a) calculates a senior persona score for the potential customer, the senior persona score including a trait qualifier score;
b) receives from the senior living community, via the data communications link, a trait qualifier for a common demographic attribute of the senior living community, the trait qualifier comprising a community-specified value for the common demographic attribute;
c) receives a trait qualifier weight assigned to said community-specified value for said common demographic attribute;
d) compares said community-specified value for said common demographic attribute to a customer value associated with the potential customer for said common demographic attribute; and
e) adds the trait qualifier weight to the trait qualifier score of senior persona score if the customer value for said common demographic attribute is equal to the community-specified value for the common demographic attribute; and
f) transmits the senior persona score for the potential customer to the display device controlled by the senior living community via the data communications link.

29. The customer lead generating system of claim 28, wherein the persona score calculator:
a) calculates a value density for the community-specified value for the common demographic attribute;
b) retrieves from the community dataset a rule for modifying the trait qualifier based on the value density calculation; and
c) modifies the trait qualifier in accordance with the rule.

30. The customer lead generating system of claim 29, wherein the web server receives the rule from the senior living community via the data communications link and stores the rule in the community dataset.

31. The customer lead generating system of claim 24, further comprising a persona score calculator that:
a) calculates a senior persona score for the potential customer, the senior persona score including an event qualifier score;
b) receives from the senior living community, via the data communications link, an event qualifier for a community demographic attribute, the event qualifier comprising a community-specified value for the senior event;
c) receives an event qualifier weight assigned to said community-specified value for said senior event;
d) compares said community-specified value for said community demographic attribute to a customer value associated with the potential customer for said community demographic attribute; and
e) adds the event qualifier weight to the event qualifier score of the senior persona score if the customer value for said senior event is equal to the community-specified value for the senior event; and
f) transmits the senior persona score for the potential customer to the display device controlled by the senior living community via the data communications link.

32. The customer lead generating system of claim 24, further comprising a persona score calculator that:
a) calculates a senior persona score for the potential customer, the senior persona score comprising the sum of a demographic qualifier score, a trait qualifier score and an event qualifier score;
b) receives from the senior living community, via the data communications link, a demographic qualifier for a senior demographic attribute, the demographic qualifier comprising a community-specified value for the senior demographic attribute;
c) receives a demographic qualifier weight assigned to said community-specified value for said senior demographic attribute;
d) receives from the senior living community, via the data communications link, a trait qualifier for a common demographic attribute of the senior living community, the trait qualifier comprising a community-specified value for the common demographic attribute;
e) receives a trait qualifier weight assigned to said community-specified value for said common demographic attribute;
f) receives from the senior living community, via the data communications link, an event qualifier for a senior event, the event qualifier comprising a community-specified value for the senior event;
g) receives an event qualifier weight assigned to said community-specified value for said senior event;
h) compares said community-specified value for said senior demographic attribute to a customer value associated with the potential customer for said senior demographic attribute;
i) adds the demographic qualifier weight to the demographic qualifier score of the senior persona score if the customer value for said senior demographic attribute is equal to the community-specified value for the first community demographic attribute.
j) compares said community-specified value for said common demographic attribute to a customer value associated with the potential customer for said common demographic attribute; and
k) adds the trait qualifier weight to the trait qualifier score of senior persona score if the customer value for said common demographic attribute is equal to the community-specified value for the common demographic attribute;
l) compares said community-specified value for said senior event to a customer value associated with the potential customer for said senior event;
m) adds the event qualifier weight to the event qualifier score of the senior persona score if the customer value for said senior event is equal to the community-specified value for the senior event; and
n) transmits the senior persona score for the potential customer to the display device controlled by the senior living community via the data communications link.

33. The customer lead generating system of claim 31, wherein:
a) the senior community matching engine creates a second potential customer record in the leads dataset, the second potential customer record comprising the customer demographic attributes for a second potential customer and the senior care type;
b) the persona score calculator calculates a second senior persona score for the second potential customer by summing together a demographic qualifier score for the second potential customer, a trait qualifier score for the second potential customer and an event qualifier score for the second potential customer;
c) the persona score calculator rank orders the potential customer and the second potential customer in accordance with the senior persona score and the second senior persona score; and
d) the persona score calculator transmits the potential customer record and the second potential customer record to a display device controlled by the senior living community in accordance with the rank ordering.

34. The customer lead generating system of claim 26, further comprising:
a) a children dataset that stores children of the seniors in the target population and children demographic attributes associated with said children; and
b) a children to senior matching engine that (i) cross-references the senior demographic attributes and the children demographic attributes to identify a senior-child relationship match between the senior in the senior population dataset and a child in the children dataset, and (ii) adds the senior-child relationship match to the potential customer record in the leads dataset.

35. The customer lead generating system of claim 34, wherein the event processor detects the early indicator based on an action of the child.

36. A computer system for calculating and displaying senior persona scores for non-resident seniors for a senior living community, comprising:
a) a microprocessor;
b) a data collector module comprising programing instructions that, when executed by the microprocessor, causes the microprocessor to monitor an external data source for events associated with seniors and senior living communities;
c) an event processor module comprising programming instructions that, when executed by the microprocessor, causes the microprocessor to (i) create a senior dataset, the senior dataset comprising senior demographic attributes, including names and addresses, for seniors in a target population, and (ii) create a community dataset, the community dataset comprising a community address, a set of common demographic attributes for the seniors who live in the senior living community, a set of operator-specified values for the set of common demographic attributes, and a set of weight rules associated with the set of operator-specified values, respectively;
d) a scoring module comprising programming instructions that, when executed by the microprocessor, causes the microprocessor to
(i) generate a trait qualifier for every operator-specified value for every common demographic attribute in the set of common demographic attributes by calculating a value density for said every operator-specified value and applying the weight rule based on said value density;
(ii) cross-reference the names and addresses of the seniors in the senior dataset with the community address in the community dataset to identify a non-resident senior for the senior living community;
(iii) use the senior demographic attributes from the senior dataset to determine the non-resident senior's value for every common demographic attribute in the set of common demographic attributes;
(iv) compare the non-resident senior's value to the operator-specified value for each common demographic attribute in the set of common demographic attributes; and
(v) add the trait qualifier for the operator-specified value to the senior persona score for the non-resident senior if the non-resident senior's value for a common demographic attribute is equal to the operator-specified value for said common demographic attribute.

37. The computer system of claim 36, wherein the scoring module comprise programming instructions that, when executed by the microprocessor, causes the microprocessor to calculate the value density for every operator-specified value for every common demographic attribute by:
a) selecting a common demographic attribute from the set of common demographic attributes;
b) determining the set of all possible values for the common demographic attribute;
and
c) for each possible value in the set of all possible values, dividing the number of seniors living in the senior living community who have said possible value for the common demographic attribute by the total number of seniors living in the senior living community.

38. The computer system of claim 36, wherein the scoring module generates the trait qualifier comprises multiplying the value density by a specified weight.

39. The computer system of claim 36, wherein the scoring module generates the trait qualifier by using a first number as the trait qualifier if the magnitude of the value density is greater than a specified percentage, and using a different number for the trait qualifier if the magnitude of the value density is less than or equal to the specified percentage.

40. The computer system of claim 36, further comprising:
a) a leads dataset for storing the senior persona score of the non-resident senior; and
b) a data communications link configured to transmit the senior persona score for the non-resident senior to a display device controlled by the senior living community.

41. A process for identifying potential job applicants for senior living communities using a lead generating system, the process comprising:
a) creating a leads dataset on the lead generating system;
b) creating a community dataset on the lead generating system by monitoring a community data source to identify and store a senior care type, a plurality of senior living communities that provide said senior care type, and community attributes associated with the plurality of senior living communities;
c) monitoring an external data source to detect a potential job applicant for a senior care type, applicant demographic attributes and applicant events for the potential job applicant;
d) on the lead generating system, comparing the applicant demographic attributes to the community attributes for a senior living community in the community dataset to establish a match between the potential job applicant and the senior living community;
e) creating a potential job applicant record in the leads dataset, the potential job applicant record comprising the applicant demographic attributes for the potential job applicant, the applicant events and the senior care type;
f) establishing a data communications link to a display device controlled by the senior living community; and
g) transmitting at least a portion of the potential job applicant record in the leads dataset from the lead generating system to the display device controlled by the senior living community via the data communications link.

42. The process of claim 41, wherein the external data source comprises one or more of:
a) a job searching database;
b) a job posting database;
c) a social networking website;
d) a college or university database;
e) a healthcare organization website;
f) a professional organization membership database; and
g) a professional services database.

43. The process of claim 41, further comprising:
a) creating a staffer dataset on the lead generating system by monitoring a demographic data source to identify and store staffers in a target population, staffer events associated with said staffers in the target population, and staff demographic attributes associated with said staffers in the target population;
b) on the lead generating system, comparing the applicant demographic attributes for the potential job applicant to the staffer demographic attributes for a staffer in the staffer dataset to establish a second match between the potential job applicant and the staffer in the senior dataset;
c) adding the applicant demographic attributes for the potential applicant to the staffer demographic attributes in the staffer dataset; and
d) adding the second match and the staffer demographic attributes for the matched staffer in the staffer dataset to the potential job applicant record in the leads dataset.

44. The process of claim 41, further comprising:
a) calculating an applicant persona score for the potential job applicant, the applicant persona score including a demographic qualifier score;
b) receiving from the senior living community, via the data communications link, a demographic qualifier for an applicant demographic attribute, the demographic qualifier comprising a community-specified value for the applicant demographic attribute;
c) receiving a demographic qualifier weight assigned to said community-specified value for said applicant demographic attribute;
d) comparing said community-specified value for said applicant demographic attribute to an applicant value associated with the potential job applicant for said applicant demographic attribute;
e) adding the demographic qualifier weight to the demographic qualifier score of the applicant persona score if the applicant value for said applicant demographic attribute is equal to the community-specified value for the applicant demographic attribute; and
f) transmitting the applicant persona score for the potential job applicant to the display device controlled by the senior living community via the data communications link.

45. The process of claim 41, further comprising:
a) calculating an applicant persona score for the potential job applicant, the applicant persona score including an event qualifier score;
b) receiving from the senior living community, via the data communications link, an event qualifier for an applicant event, the event qualifier comprising a community-specified value for the applicant event;
c) receives an event qualifier weight assigned to said community-specified value for said applicant event;
d) comparing said community-specified value for said applicant event to an applicant value associated with the potential job applicant for said applicant event; and
e) adding the event qualifier weight to the event qualifier score of the applicant persona score if the applicant value for said applicant event is equal to the community-specified value for the applicant event; and
f) transmitting the applicant persona score for the potential job applicant to the display device controlled by the senior living community via the data communications link.

46. A lead generating system for identifying potential job applicants for senior living communities, comprising:
a) a leads dataset;
b) a data collector that monitors an external data source for data associated with senior living communities and potential job applicants for senior living communities;
c) a community dataset for storing a senior care type, a plurality of senior living communities that provide said senior care type, and community attributes associated with the plurality of senior living communities;
d) an event processor that detects a potential job applicant for a senior care type, and applicant demographic attributes for the potential job applicant;
e) a staffer to community matching engine that (i) compares the applicant demographic attributes to the community attributes for a senior living community in the community dataset to establish a match between the potential job applicant and the senior living community, and (ii) creates a potential job applicant record in the leads dataset, the potential job applicant record comprising the applicant demographic attributes for the potential job applicant and the senior care type;
f) a data communications link to the senior living community; and
g) a web server that transmits at least a portion of the potential job applicant record in the leads dataset from the lead generating system to the display device controlled by the senior living community via the data communications link.

47. The lead generation system of claim 46, wherein the external data source comprises one or more of:
a) a job searching database;
b) a job posting database;
c) a social networking website;
d) a college or university database;
e) a healthcare organization website;
f) a professional organization membership database; and
g) a professional services database.

48. The lead generating system of claim 46, further comprising:
a) a staffer dataset for storing staffers in a target population, staffer demographic attributes associated with said staffers in the target population, and staff events associated with said staffers in the target population;
b) an applicant to staffer matching engine that (i) compares the applicant demographic attributes for the potential job applicant to the staffer demographic attributes for a staffer in the staffer dataset to establish a second match between the potential job applicant and the staffer in the staffer dataset, (ii) adds the applicant demographic attributes for the potential applicant to the staffer demographic attributes in the staffer dataset, and (iii) adds the second match and the staffer demographic attributes for the matched staffer in the staffer dataset to the potential job applicant record in the leads dataset.

49. The lead generating system of claim 46, further comprising an applicant persona scorer that:
a) calculates an applicant persona score for the potential job applicant, the applicant persona score including a demographic qualifier score;
b) receives from the senior living community, via the data communications link, a demographic qualifier for a staffer demographic attribute, the demographic qualifier comprising a community-specified value for the staffer demographic attribute;
c) receives a demographic qualifier weight assigned to said community-specified value for said staffer demographic attribute;
d) compares said community-specified value for said staffer demographic attribute to an applicant value associated with the potential job applicant for said staffer demographic attribute;
e) adds the demographic qualifier weight to the demographic qualifier score of the applicant persona score if the applicant value for said staffer demographic attribute is equal to the community-specified value for the staffer demographic attribute; and
f) transmits the applicant persona score for the potential job applicant to the display device controlled by the senior living community via the data communications link.

50. The lead generation system of claim 46, further comprising an applicant persona scorer that:
a) calculates an applicant persona score for the potential job applicant, the applicant persona score including an event qualifier score;
b) receives from the senior living community, via the data communications link, an event qualifier for a staffer event, the event qualifier comprising a community-specified value for the staffer event;
c) receives an event qualifier weight assigned to said community-specified value for said staffer event;
d) compares said community-specified value for said staffer event to an applicant value associated with the potential job applicant for said staffer event; and
e) adds the event qualifier weight to the event qualifier score of the applicant persona score if the applicant value for said staffer event is equal to the community-specified value for the staffer event; and
f) transmits the applicant persona score for the potential job applicant to the display device controlled by the senior living community via the data communications link.

51. A process for identifying potential communities for a senior care seeker using a lead generating system, the process comprising:
a) creating a leads dataset on the lead generating system;
b) creating a senior care seeker dataset on the lead generating system, the senior care seeker dataset comprising a senior care type and senior care seeker demographic attributes for the senior care seeker;
c) creating a community dataset on the lead generating system by monitoring a community data source to identify and store a plurality of senior living communities in the target area, community demographic attributes associated with the plurality of senior living communities in the target area, and community events associated with the plurality of senior living communities in the target area;
d) on the lead generating system, comparing the senior care seeker demographic attributes to the community demographic attributes for the plurality of senior living communities in the community dataset to establish a match between the senior care seeker, the senor care type and a potential community;
e) creating a potential community record in the leads dataset, the potential community record comprising the community demographic attributes for the potential community and the senior care type;
f) establishing a data communications link to a display device controlled by the senior care seeker; and
g) transmitting at least a portion of the potential community record in the leads dataset from the lead generating system to the display device controlled by the senior care seeker via the data communications link.

52. The process of claim 51, further comprising:
a) calculating a community persona score for the potential community, the community persona score including a demographic qualifier score;
b) receiving from the senior care seeker, via the data communications link, a demographic qualifier for a community demographic attribute, the demographic qualifier comprising a senior care seeker-specified value for the community demographic attribute;
c) receiving a demographic qualifier weight assigned to said senior care seeker-specified value for said community demographic attribute;
d) comparing said senior care seeker-specified value for said community demographic attribute to a community value associated with the potential community for said community demographic attribute;
e) adding the demographic qualifier weight to the demographic qualifier score of the senior persona score if the customer value for said community demographic attribute is equal to the community-specified value for the community demographic attribute; and
f) transmitting the community persona score for the potential community to the computer system controlled by the senior care seeker via the data communications link.

53. The process of claim 51, further comprising:
a) calculating a community persona score for the potential community, the community persona score including a trait qualifier score;
b) receiving from the senior care seeker, via the data communications link, a trait qualifier for a common demographic attribute of the senior living community, the trait qualifier comprising a senior care seeker-specified value for the common demographic attribute;
c) receiving a trait qualifier weight assigned to said senior care seeker-specified value for said common demographic attribute;
d) comparing said senior care seeker-specified value for said common demographic attribute to a community value associated with the potential community for said common demographic attribute; and
e) adding the trait qualifier weight to the trait qualifier score of the community persona score if the community value for said common demographic attribute is equal to the senior care seeker-specified value for the common demographic attribute; and
f) transmitting the community persona score for the potential community to the computer system controlled by the senior care seeker via the data communications link.

54. The process of claim 53, further comprising:
a) calculating a value density for the senior care seeker-specified value for the common demographic attribute;
b) receiving on the lead generating system a rule for modifying the trait qualifier based on the value density calculation; and
c) modifying the trait qualifier in accordance with the rule.

55. The process of claim 54, further comprising receiving the rule from the computer system controlled by the senior care seeker via the data communications link.

56. The process of claim 51, further comprising:
a) calculating a community persona score for the potential community, the community persona score including an event qualifier score;
b) receiving from the senior care seeker, via the data communications link, an event qualifier for a community event, the event qualifier comprising a senior care seeker-specified value for the community event
c) receiving an event qualifier weight assigned to said senior care seeker-specified value for said community event;
d) comparing said senior care seeker-specified value for said community event to a community value associated with the potential community for said community event; and
e) adding the event qualifier weight to the event qualifier score of the community persona score if the community value for said community event is equal to the senior care seeker-specified value for the community event; and
f) transmitting the community persona score for the non-resident senior to the display device controlled by the senior living community via the data communications link.

57. A lead generating system for identifying potential communities for a senior care seeker comprising:
a) a leads dataset;
b) a senior care seeker dataset that stores a senior care type and senior care seeker demographic attributes for the senior care seeker;
c) a data collector monitors a community data source to identify and store a plurality of senior living communities in the target area, community demographic attributes associated with the plurality of senior living communities in the target area, and community events associated with the plurality of senior living communities in the target area;
d) a senior to community matching engine that (i) compares the senior care seeker demographic attributes to the community demographic attributes for the plurality of senior living communities in the community dataset to establish a match between the senior care seeker, the senor care type and a potential community, and (iii) creates a potential community record in the leads dataset, the potential community record comprising the community demographic attributes for the potential community and the senior care type;
e) a data communications link to a display device controlled by the senior care seeker; and
f) a web server that transmits at least a portion of the potential community record in the leads dataset from the lead generating system to the display device controlled by the senior care seeker via the data communications link.

58. The lead generating system of claim 57, further comprising a persona score calculator that:
a) calculates a community persona score for the potential community, the community persona score including a demographic qualifier score;
b) receives from the senior care seeker, via the data communications link, a demographic qualifier for a community demographic attribute, the demographic qualifier comprising a senior care seeker-specified value for the community demographic attribute;
c) receives a demographic qualifier weight assigned to said senior care seeker-specified value for said community demographic attribute;
d) compares said senior care seeker-specified value for said community demographic attribute to a community value associated with the potential community for said community demographic attribute;
e) adds the demographic qualifier weight to the demographic qualifier score of the senior persona score if the customer value for said community demographic attribute is equal to the community-specified value for the community demographic attribute; and
f) transmits the community persona score for the potential community to the computer system controlled by the senior care seeker via the data communications link.

59. The lead generating system of claim 57, further comprising a persona score calculator that:
a) calculates a community persona score for the potential community, the community persona score including a trait qualifier score;
b) receives from the senior care seeker, via the data communications link, a trait qualifier for a common demographic attribute of the senior living community, the trait qualifier comprising a senior care seeker-specified value for the common demographic attribute;
c) receives a trait qualifier weight assigned to said senior care seeker-specified value for said common demographic attribute;
d) compares said senior care seeker-specified value for said common demographic attribute to a community value associated with the potential community for said common demographic attribute; and
e) adds the trait qualifier weight to the trait qualifier score of the community persona score if the community value for said common demographic attribute is equal to the senior care seeker-specified value for the common demographic attribute; and
f) transmits the community persona score for the potential community to the computer system controlled by the senior care seeker via the data communications link.

60. The lead generating system of claim 59, further comprising a persona score calculator that:
a) calculates a value density for the senior care seeker-specified value for the common demographic attribute;
b) receives a rule for modifying the trait qualifier based on the value density calculation; and
c) modifies the trait qualifier in accordance with the rule.

61. The process of claim 60, further comprising receiving the rule from the computer system controlled by the senior care seeker via the data communications link.

62. The lead generating system of claim 57, further comprising a persona score calculator that:
a) calculates a community persona score for the potential community, the community persona score including an event qualifier score;
b) receives from the senior care seeker, via the data communications link, an event qualifier for a community event, the event qualifier comprising a senior care seeker-specified value for the community event;
c) receives an event qualifier weight assigned to said senior care seeker-specified value for said community event;
d) compares said senior care seeker-specified value for said community event to a community value associated with the potential community for said community event; and
e) adds the event qualifier weight to the event qualifier score of the community persona score if the community value for said community event is equal to the senior care seeker-specified value for the community event; and
f) transmits the community persona score for the non-resident senior to the display device controlled by the senior living community via the data communications link.

63. A process for identifying potential communities for a staffer using a lead generating system, the process comprising:
a) creating a leads dataset on the lead generating system;
b) creating a staffer dataset on the lead generating system, the staffer dataset comprising a senior care type and staffer demographic attributes for the staffer;
c) creating a community dataset on the lead generating system by monitoring a community data source to identify and store a plurality of senior living communities in the target area, community demographic attributes associated with the plurality of senior living communities in the target area, and community events associated with the plurality of senior living communities in the target area;
d) on the lead generating system, comparing the staffer demographic attributes to the community demographic attributes for the plurality of senior living communities in the community dataset to establish a match between the staffer, the senor care type and a potential community;
e) creating a potential community record in the leads dataset, the potential community record comprising the community demographic attributes for the potential community and the senior care type;
f) establishing a data communications link to a display device controlled by the staffer; and
g) transmitting at least a portion of the potential community record in the leads dataset from the lead generating system to the display device controlled by the staffer via the data communications link.

64. The process of claim 63, further comprising:
a) calculating a community persona score for the potential community, the community persona score including a demographic qualifier score;
b) receiving from the staffer, via the data communications link, a demographic qualifier for a community demographic attribute, the demographic qualifier comprising a staffer-specified value for the community demographic attribute;
c) receiving a demographic qualifier weight assigned to said staffer-specified value for said community demographic attribute;
d) comparing said staffer-specified value for said community demographic attribute to a community value associated with the potential community for said community demographic attribute;
e) adding the demographic qualifier weight to the demographic qualifier score of the senior persona score if the customer value for said community demographic attribute is equal to the community-specified value for the community demographic attribute; and
f) transmitting the community persona score for the potential community to the computer system controlled by the staffer via the data communications link.

65. The process of claim 63, further comprising:
a) calculating a community persona score for the potential community, the community persona score including an event qualifier score;
b) receiving from the staffer, via the data communications link, an event qualifier for a community event, the event qualifier comprising a staffer-specified value for the community event;
c) receiving an event qualifier weight assigned to said staffer-specified value for said community event;
d) comparing said staffer-specified value for said community event to a community value associated with the potential community for said community event; and
e) adding the event qualifier weight to the event qualifier score of the community persona score if the community value for said community event is equal to the staffer-specified value for the community event; and
f) transmitting the community persona score for the non-resident senior to the display device controlled by the senior living community via the data communications link.
